(19) United States
(12) Patent Application Publication
(10) Pub. No.: US 2018/0062904 A1
(43) Pub. Date: Mar. 1, 2018

(54) SYMBOL-MAPPING METHOD AND RADIO DEVICE FOR DECREASING PAPR

(71) Applicant: LG ELECTRONICS INC., Seoul (KR)

(72) Inventors: Seunggye HWANG, Seoul (KR); Hyangsun YOU, Seoul (KR); Bonghoe KIM, Seoul (KR); Kijun KIM, Seoul (KR); Yunjung YI, Seoul (KR)

(73) Assignee: LG ELECTRONICS INC., Seoul (KR)

(21) Appl. No.: 15/565,297

(22) PCT Filed: Apr. 18, 2016
(86) PCT No.: PCT/KR2016/003979

§ 371 Date: Oct. 9, 2017

Related U.S. Application Data
(60) Provisional application No. 62/148,738, filed on Apr. 16, 2015.
(60) Provisional application No. 62/264,856, filed on Dec. 8, 2015.

(51) Int. Cl. H04L 27/34; H04L 27/26; H04L 5/00

(52) U.S. Cl. CPC H04L 27/3411; H04L 67/12; H04L 5/0048; H04L 27/2615

(57) ABSTRACT

One disclosure of the present specification provides a method for mapping data symbols in a wireless communication system. The method comprises the steps of: generating a first symbol sequence in which first symbols among data symbols to be transmitted are consecutively arranged; generating a second symbol sequence in which second symbols among the data symbols are consecutively arranged; and performing modulation of the first and second symbol sequences, wherein the step of performing modulation may be a phase rotation on the boundary of the first symbol sequence and the second symbol sequence.

### BACKGROUND OF THE INVENTION

### Field of the Invention

The present invention relates to mobile communication.

### Related Art

3rd generation partnership project (3GPP) long term evolution (LTE) evolved from a universal mobile telecommunications system (UMTS) is introduced as the 3GPP release 8. The 3GPP LTE uses orthogonal frequency division multiple access (OFDMA) in a downlink, and uses single carrier-frequency division multiple access (SC-FDMA) in an uplink. The 3GPP LTE uses multiple input multiple output (MIMO) having up to four antennas.

As disclosed in 3GPP TS 36.211 V10.4.0 (2011-12) “Evolved Universal Terrestrial Radio Access (E-UTRA); Physical Channels and Modulation (Release 10)”, a physical channel of LTE may be classified into a downlink channel, i.e., a physical downlink shared channel (PDSCH) and a physical downlink control channel (PDCCH), and an uplink channel, i.e., a physical uplink shared channel (PUSCH) and a physical uplink control channel (PUCCH).

Meanwhile, in recent years, research into communication between devices or the device and a server without human interaction, that is, without human intervention, that is, Internet of Things (IoT) has been actively conducted. The IoT represents a concept in which not a terminal used by the human, but a machine performs communication using the existing wireless communication network.

Since IoT has features different from communication of a normal UE, a service optimized to IoT may differ from a service optimized to human-to-human communication. In comparison with a current mobile network communication service, IoT may be characterized by a different market scenario, data communication, a lower cost, less efforts, a potentially great number of IoT devices, wide service areas, low traffic for each IoT device, etc.

Meanwhile, for an IoT device, to extend or enhance cell coverage of an eNB is taken into consideration. However, if an IoT device is located in a coverage extension (CE) or coverage enhancement (CE) area, it cannot correctly receive a downlink channel. To this end, what an eNB repeatedly transmits the same downlink channel on a plurality of subframes and the IoT device repeatedly transmits the same uplink channel on a plurality of subframes may be taken into consideration.

However, such repetitive transmission may increase a peak-to-average power ratio, and an increased PAPR may become a burden on IoT devices that require low complexity and a low cost.

### SUMMARY OF THE INVENTION

An object of one disclosure of this specification is to provide a symbol mapping method capable of reducing the PAPR in IoT communication and a wireless device for performing the symbol mapping method.

In order to achieve the aforementioned objects, one disclosure of this specification provides a method of mapping a data symbol in a wireless communication system. The method includes the steps of generating a first symbol sequence in which only a first symbol of data symbols to be transmitted is contiguously repeated and disposed; generating a second symbol sequence in which only a second symbol of the data symbols to be transmitted is contiguously repeated and disposed; and performing modulation on the first and the second symbol sequences. In the step of performing the modulation, a phase rotation may be performed at a boundary changed from the first symbol sequence to the second symbol sequence.

In the step of performing the modulation, the phase rotation may not be performed in a period in which the repetition of the first symbol is maintained within the first symbol sequence.

In the step of performing the modulation, an additional symbol may be inserted into the boundary of the first symbol sequence and the second symbol sequence, wherein the phase of the additional symbol may be determined to be a middle value of a phase of the first symbol sequence and a phase of the second symbol sequence.

In the step of performing the modulation, the phase of a data symbol located at the last of the first symbol sequence may be rotated based on the phase of a data symbol located at the first of the second symbol sequence.

In the step of performing the modulation, the phase of the data symbol located at the first of the second symbol sequence may be rotated based on the rotated phase of the data symbol located at the last of the first symbol sequence.

In the step of performing the modulation, if the first symbol sequence may include a special symbol whose phase has been previously reserved, the phase of a data symbol to be disposed to neighbor the special symbol may be rotated based on the phase of the special symbol.

The method of claim 6, In the step of performing the modulation, the phase of a third symbol located right before the special symbol may be rotated so that the phase becomes a middle value of a phase of a symbol sequence to which the third symbol belongs and the phase of the special symbol.

In the step of performing the modulation, a phase of a fourth symbol located right after the special symbol may be rotated so that the phase becomes a middle value of a phase of a symbol sequence to which the fourth symbol belongs and the phase of the special symbol.

In the step of performing the modulation, the phase of the first symbol is determined, wherein the phase of the first symbol may be determined by taking into consideration the phases of two data symbols located right before and right after the first symbol.

In the step of performing the modulation, a value obtained by adding a phase value of the first symbol, a phase value of a third symbol located right before the first symbol, and a phase value of a fourth symbol located right after the first symbol and then dividing the added value by 3 may be determined to be the phase value of the first symbol.

In the step of performing the modulation, a value obtained by adding a phase value of the first symbol and any one of a phase value of a third symbol located right before the first symbol and a phase value of a fourth symbol located right after the first symbol and then dividing the added value by 2 may be determined to be the phase value of the first symbol.

In the step of generating the first symbol sequence, the first symbol sequence may be segmented into a plurality of first subsets. In the step of generating the second symbol sequence, the second symbol sequence may be segmented into a plurality of second subsets. A third symbol sequence may be generated by mapping the plurality of first subsets and the plurality of second subsets in accordance with a predetermined resource mapping rule.

In the step of generating the first symbol sequence, if the first symbol sequence includes a special symbol whose location has been previously reserved, the size of the first subset may be determined based on the location of the special symbol, and the first symbol sequence may be segmented into the plurality of first subsets based on the determined size.

In order to achieve the aforementioned objects, another disclosure of this specification provides a wireless device mapping a data symbol in a wireless communication system. The wireless device includes a transceiver unit and a processor controlling the transceiver unit. The processor may perform a procedure of generating a first symbol sequence in which only a first symbol of data symbols to be transmitted is contiguously repeated and disposed, generating a second symbol sequence in which only a second symbol of the data symbols to be transmitted is contiguously repeated and disposed, and performing modulation on the first and the second symbol sequences. In the procedure of performing the modulation, the processor may perform a phase rotation a boundary changed from the first symbol sequence to the second symbol sequence.

In accordance with one disclosure of this specification, an increase of the PAPR attributable to a phase difference between symbols can be suppressed. Furthermore, the generation of zero-crossing can be prevented, and a constant envelope can be maintained.

### BRIEF DESCRIPTION OF THE DRAWINGS

FIG. 1 is an example of a wireless communication system.

FIG. 2 illustrates the structure of a radio frame according to FDD in 3GPP LTE.

FIG. 3 illustrates the structure of a downlink radio frame according to TDD in the 3GPP LTE.

FIG. 4 is an exemplary diagram illustrating a resource grid for one uplink or downlink slot in the 3GPP LTE.

FIG. 5 illustrates the structure of a downlink subframe in 3GPP LTE.

FIG. 6 illustrates the structure of an uplink subframe in 3GPP LTE.

FIG. 7 is an example of a comparison between a single carrier system and a carrier aggregation system.

FIGS. 8a and 8b show frame structures for the transmission of a synchronization signal in a normal CP and an extended CP, respectively.

FIG. 9 shows an example of Internet of Things (IoT) communication.

FIG. 10 is an exemplary diagram showing an uplink resource grid in the NB-IoT.

FIG. 11 is an example of cell coverage extension or enhancement for an IoT device.

FIG. 12 is an exemplary diagram showing an example of bundle transmission.

FIGS. 13a and 13b are exemplary diagrams showing some examples of a redundancy version (RV) for bundle transmission.

FIG. 14 is an exemplary diagram showing an example in which the same precoding has been applied while a plurality of subframes is transmitted.

FIGS. 15a and 15b are exemplary diagrams showing some examples of a subband in which an IoT UE operates.

FIG. 16 is an exemplary diagram showing an example of a process in which a transport block is mapped to resources.

FIGS. 17a and 17b are exemplary diagrams showing some examples of a process in which N subframes are repeated and transmitted N times.

FIGS. 18, 19 and 20 are exemplary diagrams showing examples of symbols allocated according to symbol repetition set types 1, 2 and 3, respectively.

FIGS. 21, 22, 23 and 24 are exemplary diagrams showing examples of phases rotated according to phase rotation types A, B, C and D, respectively.

FIG. 25 is an exemplary diagram showing an example of a phase rotated by taking into consideration quadrature phase shift keying (QPSK) modulation according to a modulation method 1.

FIG. 26 is an exemplary diagram showing all of paths which may occur due to a phase change into which binary PSK (BPSK), QPSK and 8-BPSK modulation are taken into consideration according to the modulation method 1.

FIG. 27 is an exemplary diagram showing an example of a phase rotated into which QPSK modulation is taken into consideration according to a modulation method 2.

FIG. 28 is an exemplary diagram showing all of paths which may occur due to a phase change into which BPSK, QPSK and 8-BPSK modulation are taken into consideration according to the modulation method 2.

FIG. 29 is a flowchart illustrating a symbol mapping method for a reduction of the PAPR according to this specification.

FIG. 30 is a block diagram of a wireless communication system in which one disclosure of this specification is implemented.

### DESCRIPTION OF EXEMPLARY EMBODIMENTS

Hereinafter, based on 3rd Generation Partnership Project (3GPP) long term evolution (LTE) or 3GPP LTE-advanced (LTE-A), the present invention will be applied. This is just an example, and the present invention may be applied to various wireless communication systems. Hereinafter, LTE includes LTE and/or LTE-A.

The technical terms used herein are used to merely describe specific embodiments and should not be construed as limiting the present invention. Furthermore, the technical terms used herein should be, unless defined otherwise, interpreted as having meanings generally understood by those skilled in the art but not too broadly or too narrowly. Furthermore, the technical terms used herein, which are determined not to exactly represent the spirit of the invention, should be replaced by or understood by such technical terms as being able to be exactly understood by those skilled in the art. Furthermore, the general terms used herein should be interpreted in the context as defined in the dictionary, but not in an excessively narrowed manner.

The expression of the singular number in the present invention includes the meaning of the plural number unless the meaning of the singular number is definitely different from that of the plural number in the context. In the following description, the term ‘include’ or ‘have’ may represent the existence of a feature, a number, a step, an operation, a component, a part or the combination thereof described in the present invention, and may not exclude the existence or addition of another feature, another number, another step, another operation, another component, another part or the combination thereof.

The terms ‘first’ and ‘second’ are used for the purpose of explanation about various components, and the components are not limited to the terms ‘first’ and ‘second’. The terms ‘first’ and ‘second’ are only used to distinguish one component from another component. For example, a first component may be named as a second component without deviating from the scope of the present invention.

It will be understood that when an element or layer is referred to as being “connected to” or “coupled to” another element or layer, it may be directly connected or coupled to the other element or layer or intervening elements or layers may be present. In contrast, when an element is referred to as being “directly connected to” or “directly coupled to” another element or layer, there are no intervening elements or layers present.

Hereinafter, exemplary embodiments of the present invention will be described in greater detail with reference to the accompanying drawings. In describing the present invention, for ease of understanding, the same reference numerals are used to denote the same components throughout the drawings, and repetitive description on the same components will be omitted. Detailed description on well-known arts which are determined to make the gist of the invention unclear will be omitted. The accompanying drawings are provided to merely make the spirit of the invention readily understood, but not should be intended to be limiting of the invention. It should be understood that the spirit of the invention may be expanded to its modifications, replacements or equivalents in addition to what is shown in the drawings.

As used herein, a ‘base station’ generally refers to a fixed station that communicates with a wireless device and may be denoted by other terms, such as an evolved-NodeB (eNB), a base transceiver system (BTS) or an access point.

As used herein, a ‘user equipment (UE)’ may be stationary or mobile, and may be denoted by other terms, such as a device, a wireless device, a terminal, a mobile station (MS), a user terminal (UT), a subscriber station (SS) or a mobile terminal (MT).

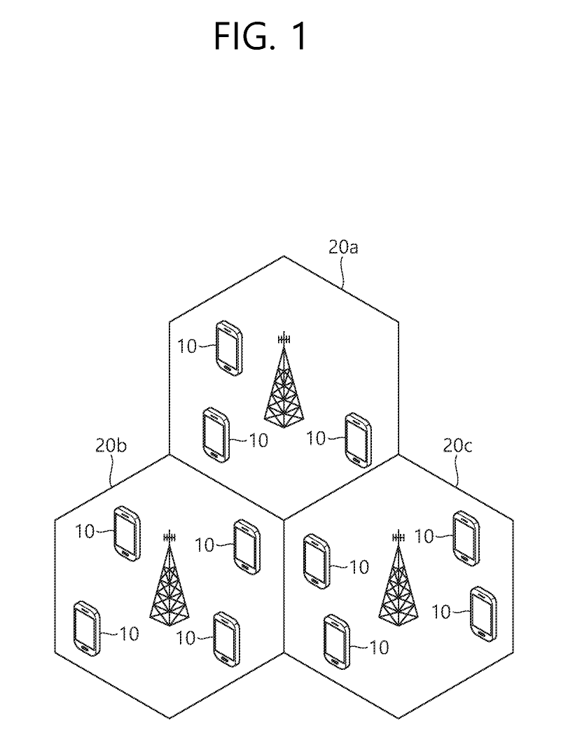

FIG. 1 illustrates a wireless communication system.

As seen with reference to FIG. 1, the wireless communication system includes at least one base station (BS) 20. Each base station 20 provides a communication service to specific geographical areas (commonly referred to as cells) 20a, 20b, and 20c. The cell may be further divided into a plurality of areas (sectors).

The UE generally belongs to one cell and the cell to which the UE belong is referred to as a serving cell. A base station that provides the communication service to the serving cell is referred to as a serving BS. Since the wireless communication system is a cellular system, another cell that neighbors to the serving cell is present. Another cell which neighbors to the serving cell is referred to a neighbor cell. A base station that provides the communication service to the neighbor cell is referred to as a neighbor BS. The serving cell and the neighbor cell are relatively decided based on the UE.

Hereinafter, a downlink means communication from the base station 20 to the UE 10 and an uplink means communication from the UE 10 to the base station 20. In the downlink, a transmitter may be a part of the base station 20 and a receiver may be a part of the UE 10. In the uplink, the transmitter may be a part of the UE 10 and the receiver may be a part of the base station 20.

Meanwhile, the wireless communication system may be generally divided into a frequency division duplex (FDD) type and a time division duplex (TDD) type. According to the FDD type, uplink transmission and downlink transmission are achieved while occupying different frequency bands. According to the TDD type, the uplink transmission and the downlink transmission are achieved at different time while occupying the same frequency band. A channel response of the TDD type is substantially reciprocal. This means that a downlink channel response and an uplink channel response are approximately the same as each other in a given frequency area. Accordingly, in the TDD based wireless communication system, the downlink channel response may be acquired from the uplink channel response. In the TDD type, since an entire frequency band is time-divided in the uplink transmission and the downlink transmission, the downlink transmission by the base station and the uplink transmission by the terminal may not be performed simultaneously. In the TDD system in which the uplink transmission and the downlink transmission are divided by the unit of a subframe, the uplink transmission and the downlink transmission are performed in different subframes.

Hereinafter, the LTE system will be described in detail.

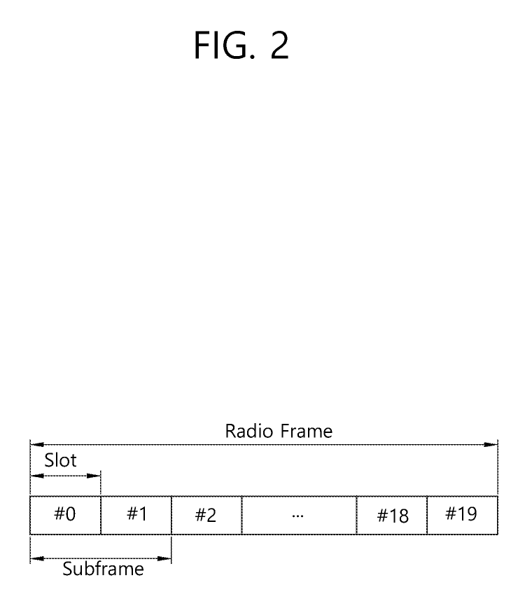

FIG. 2 shows a downlink radio frame structure according to FDD of 3rd generation partnership project (3GPP) long term evolution (LTE).

The radio frame of FIG. 2 may be found in the section 5 of 3GPP TS 36.211 V10.4.0 (2011-12) “Evolved Universal Terrestrial Radio Access (E-UTRA); Physical Channels and Modulation (Release 10)”.

The radio frame includes 10 sub-frames indexed 0 to 9. One sub-frame includes two consecutive slots. Accordingly, the radio frame includes 20 slots. The time taken for one sub-frame to be transmitted is denoted TTI (transmission time interval). For example, the length of one sub-frame may be 1 ms, and the length of one slot may be 0.5 ms.

The structure of the radio frame is for exemplary purposes only, and thus the number of sub-frames included in the radio frame or the number of slots included in the sub-frame may change variously.

Meanwhile, one slot may include a plurality of OFDM symbols. The number of OOFDM symbols included in one slot may vary depending on a cyclic prefix (CP).

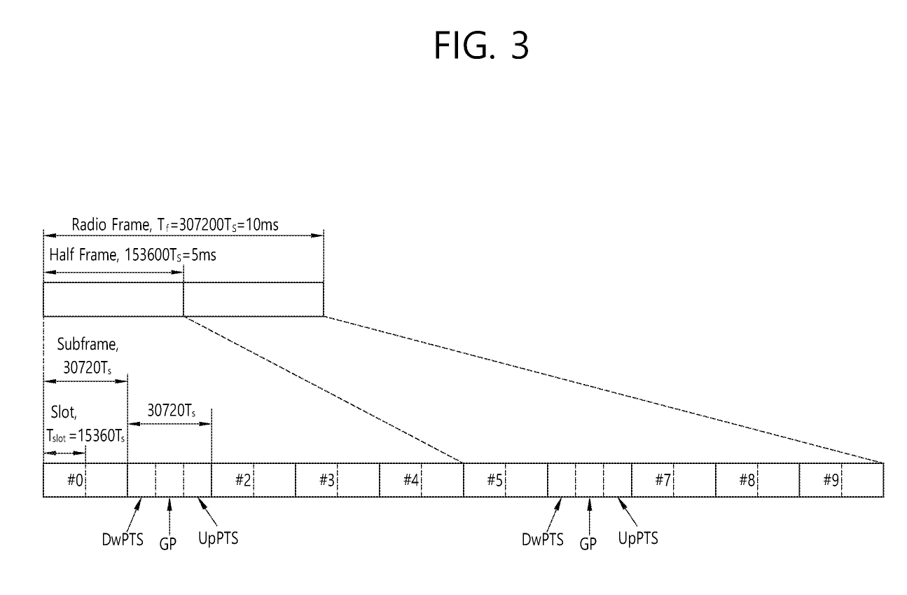

FIG. 3 illustrates the architecture of a downlink radio frame according to TDD in 3GPP LTE.

For this, 3GPP TS 36.211 V10.4.0 (2011-23) “Evolved Universal Terrestrial Radio Access (E-UTRA); Physical Channels and Modulation (Release 8)”, Ch. 4 may be referenced, and this is for TDD (time division duplex).

Sub-frames having index #1 and index #6 are denoted special sub-frames, and include a DwPTS (Downlink Pilot Time Slot: DwPTS), a GP (Guard Period) and an UpPTS (Uplink Pilot Time Slot). The DwPTS is used for initial cell search, synchronization, or channel estimation in a terminal. The UpPTS is used for channel estimation in the base station and for establishing uplink transmission sync of the terminal. The GP is a period for removing interference that arises on uplink due to a multi-path delay of a downlink signal between uplink and downlink.

In TDD, a DL (downlink) sub-frame and a UL (Uplink) co-exist in one radio frame. Table 1 shows an example of configuration of a radio frame.

TABLE 1

| | Switch- | | | | | | | | | | |
|---|---|---|---|---|---|---|---|---|---|---|---|
| UL-DL | point | Subframe index | | | | | | | | | |
| configuration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

‘D’ denotes a DL sub-frame, ‘U’ a UL sub-frame, and ‘S’ a special sub-frame. When receiving a UL-DL configuration from the base station, the terminal may be aware of whether a sub-frame is a DL sub-frame or a UL sub-frame according to the configuration of the radio frame.

TABLE 2

| Special | Normal CP in downlink | | | Extended CP in downlink | | |
|---|---|---|---|---|---|---|
| sub- | | UpPTS | | | UpPTS | |
| frame | | Normal | Extended | | Normal | Extended |
| config- | | CP in | CP | | CP in | CP |
| uration | DwPTS | uplink | in uplink | DwPTS | uplink | in uplink |
| 0 | 6592*Ts | 2192*Ts | 2560*Ts | 7680*Ts | 2192*Ts | 2560*Ts |
| 1 | 19760*Ts | | | 20480*Ts | | |
| 2 | 21952*Ts | | | 23040*Ts | | |
| 3 | 24144*Ts | | | 25600*Ts | | |
| 4 | 26336*Ts | | | 7680*Ts | 4384*Ts | 5120*ts |
| 5 | 6592*Ts | 4384*Ts | 5120*ts | 20480*Ts | | |
| 6 | 19760*Ts | | | 23040*Ts | | |
| 7 | 21952*Ts | | | — | | |
| 8 | 24144*Ts | | | — | | |

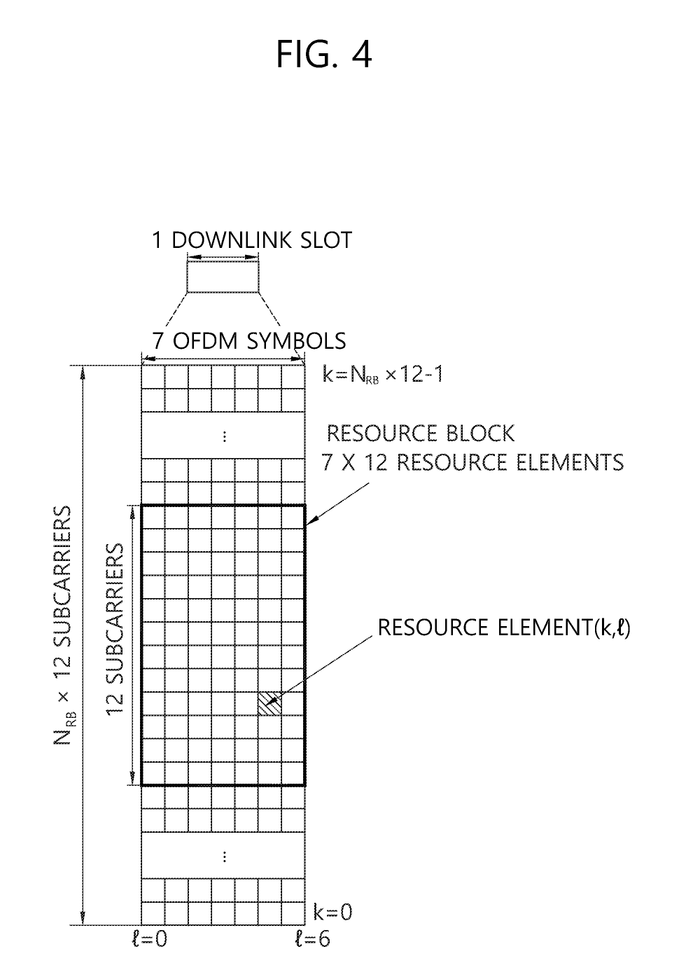

FIG. 4 illustrates an example resource grid for one uplink or downlink slot in 3GPP LTE.

Referring to FIG. 4, the uplink slot includes a plurality of OFDM (orthogonal frequency division multiplexing) symbols in the time domain and NRB resource blocks (RBs) in the frequency domain. For example, in the LTE system, the number of resource blocks (RBs), i.e., an NRB, may be one of 6 to 110.

The resource block is a unit of resource allocation and includes a plurality of sub-carriers in the frequency domain. For example, if one slot includes seven OFDM symbols in the time domain and the resource block includes 12 sub-carriers in the frequency domain, one resource block may include 7×12 resource elements (REs).

Meanwhile, the number of sub-carriers in one OFDM symbol may be one of 128, 256, 512, 1024, 1536, and 2048.

In 3GPP LTE, the resource grid for one uplink slot shown in FIG. 4 may also apply to the resource grid for the downlink slot.

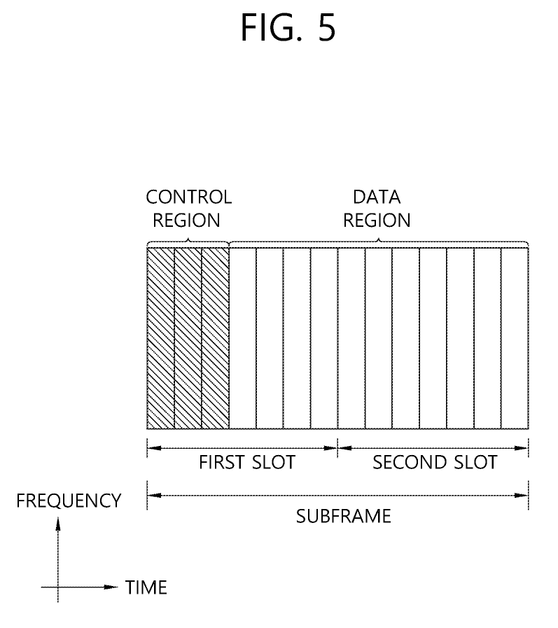

FIG. 5 illustrates the architecture of a downlink sub-frame.

In FIG. 5, in the case of a normal CP, one slot includes seven OFDM symbols, by way of example.

A downlink (DL) sub-frame is split into a control region and a data region in the time domain. The control region includes up to first three OFDM symbols in the first slot of the sub-frame. However, the number of OFDM symbols included in the control region may be changed. A PDCCH (physical downlink control channel) and other control channels are assigned to the control region, and a PDSCH is assigned to the data region.

The physical channels in 3GPP LTE may be classified into data channels such as PDSCH (physical downlink shared channel) and PUSCH (physical uplink shared channel) and control channels such as PDCCH (physical downlink control channel), PCFICH (physical control format indicator channel), PHICH (physical hybrid-ARQ indicator channel) and PUCCH (physical uplink control channel).

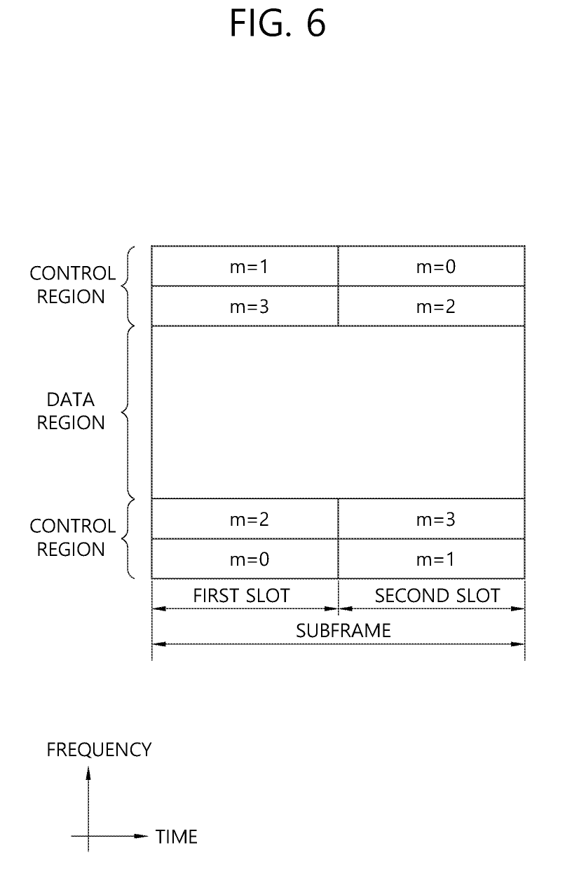

FIG. 6 illustrates the structure of an uplink subframe in 3GPP LTE.

Referring to FIG. 6, an uplink subframe may be divided into a control region and a data region in a frequency domain. The control region is allocated a PUCCH for transmission of uplink control information. The data region is allocated a PUSCH for the transmission of data (along with control information in some cases).

A PUCCH for one UE is allocated an RB pair in a subframe. The RBs of the RB pair occupy different subcarriers in first and second slots. A frequency occupied by the RBs of the RB pair allocated to the PUCCH changes with respect to a slot boundary, which is described as the RB pair allocated to the PUCCH having been frequency-hopped on the slot boundary.

A UE transmits uplink control information through different subcarriers according to time, thereby obtaining a frequency diversity gain. m is a location index indicating the logical frequency-domain location of an RB pair allocated for a PUCCH in a subframe.

Uplink control information transmitted on a PUCCH may include a HARQ ACK/NACK, a channel quality indicator (CQI) indicating the state of a downlink channel, a scheduling request (SR) which is an uplink radio resource allocation request, or the like.

A PUSCH is mapped to a uplink shared channel (UL-SCH) as a transport channel Uplink data transmitted on a PUSCH may be a transport block as a data block for a UL-SCH transmitted during a TTI. The transport block may be user information. Alternatively, the uplink data may be multiplexed data. The multiplexed data may be the transport block for the UL-SCH multiplexed with control information. For example, control information multiplexed with data may include a CQI, a precoding matrix indicator (PMI), an HARQ, a rank indicator (RI), or the like. Alternatively, the uplink data may include only control information.

Hereinafter, a carrier aggregation (CA) is described.

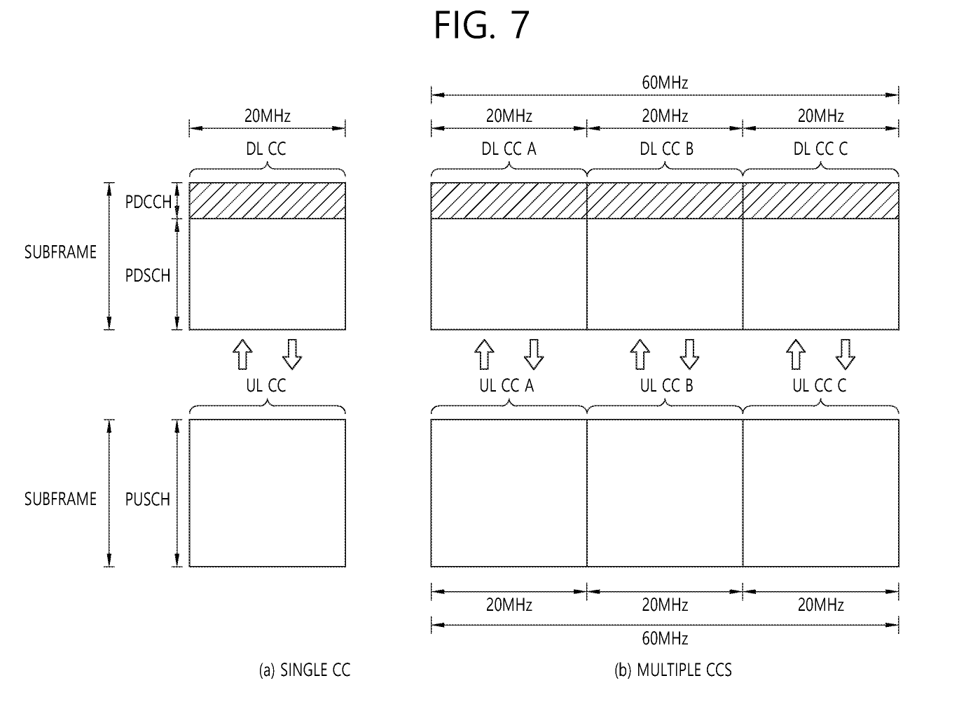

FIG. 7 is an example of a comparison between a single carrier system and a carrier aggregation system.

Referring to FIG. 7, in a single carrier system, only one carrier is supported for a UE in uplink and downlink. The bandwidth of a carrier may be various, but the number of carriers allocated to a UE is one. In contrast, in a carrier aggregation (CA) system, a plurality of component carriers (DL CCs A to C, UL CCs A to C) may be allocated to a UE. The component carrier (CC) means a carrier used in the carrier aggregation system and may be abbreviated as a carrier. For example, 3 CCs of 20 MHz may be allocated to a UE in order to allocate a bandwidth of 60 MHz to the UE.

A CA system may be divided into a contiguous CA system in which aggregated carriers are contiguous and a non-contiguous CA system in which aggregated carriers are separated. If a CA system is simply called hereinafter, it should be understood that the CA system includes both a case where CCs are contiguous and a case where CCs are non-contiguous.

A CC, that is, a target when one or more CCs are aggregated, may use a bandwidth used in an existing system without any change for backward compatibility with the existing system. For example, the 3GPP LTE system supports bandwidths of 1.4 MHz, 3 MHz, 5 MHz, 10 MHz, 15 MHz and 20 MHz. In the 3GPP LTE-A system, a broadband of 20 MHz or higher may be configured using only the bandwidths of the 3GPP LTE system. Furthermore, a new bandwidth may be defined and a broadband may be configured using the new bandwidth without using the bandwidth of the existing system without any change.

The system frequency band of a wireless communication system is divided into a plurality of carrier frequencies. In this case, the carrier frequency means the center frequency of a cell. Hereinafter, a cell may mean a downlink frequency resource and an uplink frequency resource. Alternatively, the cell may mean a combination of a downlink frequency resource and an optional uplink frequency resource. Furthermore, in general, if a carrier aggregation (CA) is not taken into consideration, uplink and downlink frequency resources may be always present in one cell as a pair.

In order for packet data to be transmitted and received through a specific cell, a UE must first complete a configuration for the specific cell. In this case, the configuration means the state in which the reception of system information necessary to transmit and receive data for a corresponding cell has been completed. For example, the configuration may include an overall process of receiving common physical parameters necessary to transmit and receive data, media access control (MAC) layer parameters or parameters necessary for a specific operation in the RRC layer. A cell whose configuration has been completed can immediately transmit and receive a packet when it has only to receive information indicating that packet data can be transmitted.

A cell in the configuration complete state may be present in an activation or deactivation state. In this case, activation means that the transmission or reception of data is being performed or in a ready state. A UE may monitor or receive a control channel (PDCCH) and data channel (PDSCH) of an activated cell in order to check a resource (frequency or time) allocated thereto.

Deactivation means that the transmission or reception of traffic data is impossible and measurement or the transmission/reception of minimum information is possible. A UE may receive system information (SI) necessary to receive a packet from a deactivated cell. In contrast, a UE does not monitor or receive a control channel (PDCCH) and data channel (PDSCH) of a deactivated cell in order to check a resource (frequency or time) allocated thereto.

Hereinafter, a synchronization signal (SS) is described.

In the LTE/LTE-A system, in a cell search procedure, synchronization with a cell is obtained through a synchronization signal (SS).

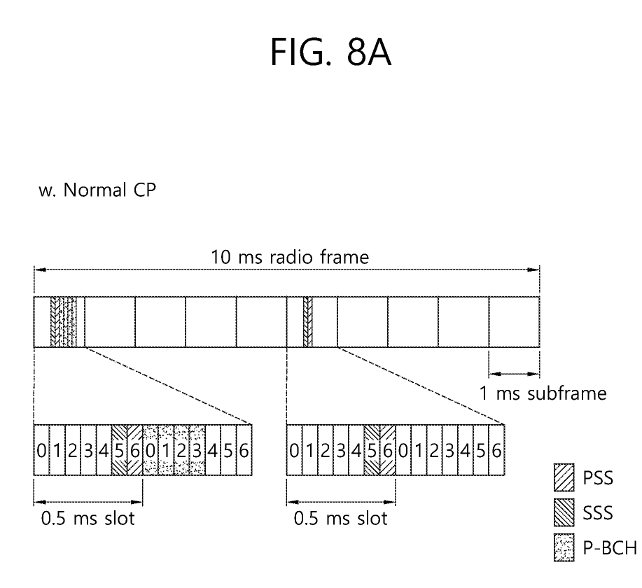

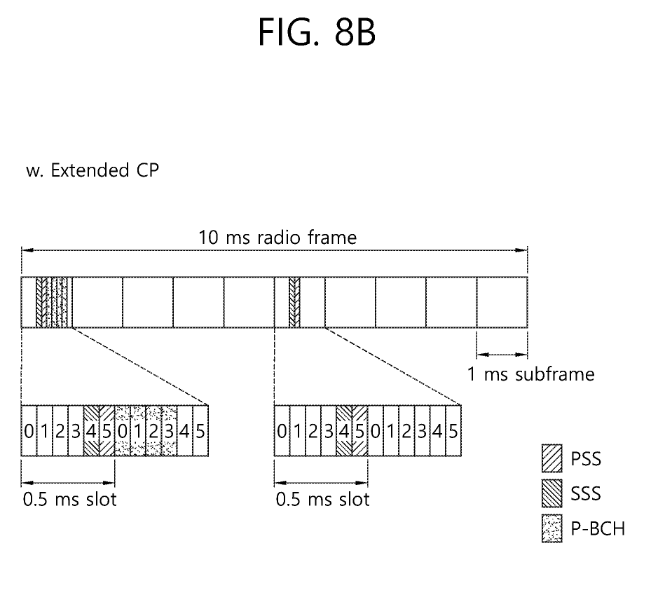

FIGS. 8a and 8b show frame structures for the transmission of a synchronization signal in a normal CP and an extended CP, respectively.

Referring to FIGS. 8a and 8b, a synchronization signal (SS) is transmitted in the second slot of each of a subframe No. 0 and a subframe No. 5 by taking into consideration 4.6 ms, that is, a GSM frame length, for the easy of inter-RAT measurement. The boundary of a corresponding radio frame may be detected through a secondary synchronization signal (S-SS).

A primary synchronization signal (P-SS) is transmitted in the last OFDM symbol of a corresponding slot, and an S-SS is transmitted in an OFDM symbol right before the P-SS.

A synchronization signal (SS) may transmit a total of 504 physical cell IDs through a combination of 3 P-SSs and 168 S-SSs.

Furthermore, a synchronization signal (SS) and a physical broadcast channel (PBCH) are transmitted within 6 RBs in the middle of a system bandwidth so that a UE can detect or decode them regardless of a transmission bandwidth.

Hereinafter, a narrow band-IoT (NB-IoT) is described.

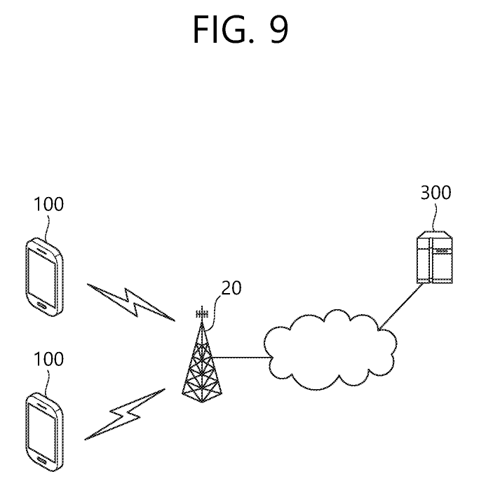

FIG. 9 shows an example of Internet of Things (IoT) communication.

IoT refers to a direct information exchange between IoT UEs 100, an information exchange between the IoT UEs 100 through an eNB 20, or an information exchange between the IoT UE 100 and an IoT server 300 without the intervention of a human interaction. Furthermore, the NB-IOT is IoT that uses a narrowband.

The IoT UE 100 is a wireless device providing IoT communication and may be fixed to one point or may have mobility.

The IoT server 300 is an entity capable of communicating with the IoT UE 100. The IoT server 300 may execute an IoT application and provide IoT services to the IoT UE 100.

The IoT service is different from a service in communication in which a person is involved in a conventional technology, and may include a variety of categories of services, such as tracking, metering, payment, a medical field service and remote control. For example, the IoT service may include meter reading, water level measurement, the utilization of a surveillance camera, and the inventory report of vending machines.

It is preferred that in IoT communication, the cost of the IoT UE 100 is reduced and the amount of battery power consumed is reduced in line with a low data transfer rate because the IoT communication has characteristics in that the amount of transmission data is small and uplink or downlink data is rarely transmitted and received. Furthermore, the IoT UE 100 has a characteristic in that a channel environment is rarely changed because it has a characteristic in that it has low mobility.

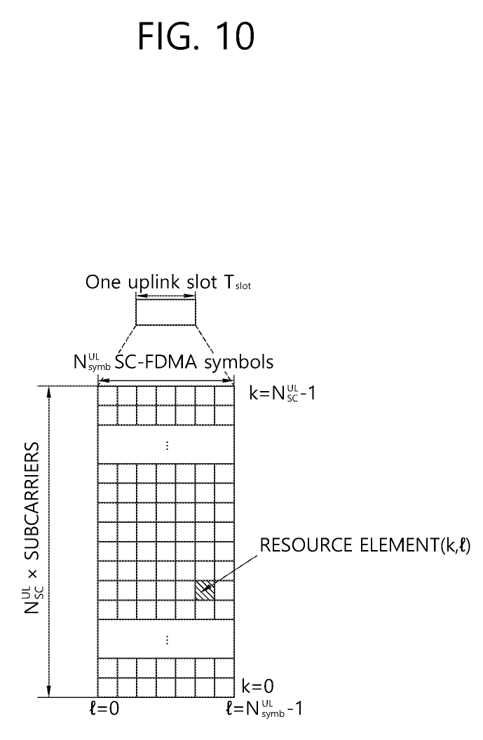

FIG. 10 is an exemplary diagram showing an uplink resource grid in the NB-IoT.

Referring to FIG. 10, a physical channel or physical signal transmitted on a slot in uplink of an NB-IoT includes N_{symb}^{UL} SC-FDMA symbols in a time domain and includes N_{SC}UL subcarriers in a frequency domain. The physical channel of uplink may be divided into a narrowband physical uplink shared channel (NPUSCH) and a narrowband physical random access channel (NPRACH). Furthermore, in the NB-IoT, the physical signal may be a narrowband demodulation reference signal (NDMRS).

In the NB-IoT, the uplink bandwidth N_{sc}^{UL} subcarriers during a Tₛₗₒₜ slot is as follows.

TABLE 3

| Subcarrier spacing | N_{sc}^{UL} | Tₛₗₒₜ |
|---|---|---|
| Δf = 3.75 kHz | 48 | 61440 * Tₛ |
| Δf = 15 kHz | 12 | 15360 * Tₛ |

In the NB-IoT, each resource element (RE) of the resource grid is k=0, . . . , N_{sc}^{UL}−1 indicative of the time domain and the frequency domain. If 1=0, . . . , N_{symb}^{UL}−1, the RE may be defined as an index pair (k, 1) within a slot.

In the NB-IoT, a resource unit (RU) is used to map an NPUSCH, etc. to a resource element (RE). The RU is defined as a contiguous subcarrier N_{SC}^{RU} and contiguous SC-FDMA symbol N_{symb}^{UL} Nₛₗₒₜₛ^{UL} in the frequency domain.

In this case, N_{sc}^{RU}, N_{symb}^{UL} and Nₛₗₒₜₛ^{UL} are as follows.

TABLE 4

| Δf | N_{sc}^{RU} | Nₛₗₒₜₛ^{UL} | N_{symb}^{UL} |
|---|---|---|---|
| 3.75 kHz | 1 | 16 | 7 |
| 15 kHz | 1 | 16 | |
| | 3 | 8 | |
| | 6 | 4 | |
| | 12 | 2 | |

Symbol blocks z(0), z(M_{symb}^{aP}−1) are multiplied by an amplitude scaling factor according to transmission power P_{NPUSCH}, and are sequentially mapped to subcarriers allocated for the transmission of an NPUSCH from z(0). The mapping for a resource element (k, 1) is performed in an increasing sequence from an index k to an index 1, starting from a first slot within a resource unit (RU). The NPUSCH may be mapped to one or more resource units (RUs).

In the NB-IoT, a downlink physical channel corresponds to a set of resource elements that carry information originated from a higher layer. The downlink physical channel may be divided into a narrowband physical downlink shared channel (NPDSCH), a narrowband physical broadcast channel (NPBCH) and a narrowband physical downlink control channel (NPDCCH).

In the NB-IoT, a downlink physical signal is used by a physical layer, but corresponds to sets of resource elements that do not carry information originated from a higher layer. The downlink physical signal may be divided into a narrowband reference signal (NRS) and a narrowband synchronization signal (NSS).

In downlink of the NB-IoT, a signal transmitted on one antenna port may be expressed as a resource grid of one resource block size. In a downlink bandwidth, only Δf=15 kHz is supported.

With respect to each antenna port used for the transmission of a physical channel, symbol blocks y^{(p)}(0), . . . , y^{(p)}(M_{symb}^{ap}−1) are sequentially mapped to the resource element (k, 1) from y^{(p)}(0). The mapping for the resource element (k, 1) on an antenna port p is performed according to an increasing sequence from an index k to an index 1 in the second slot of a subframe, starting from the first slot of the subframe.

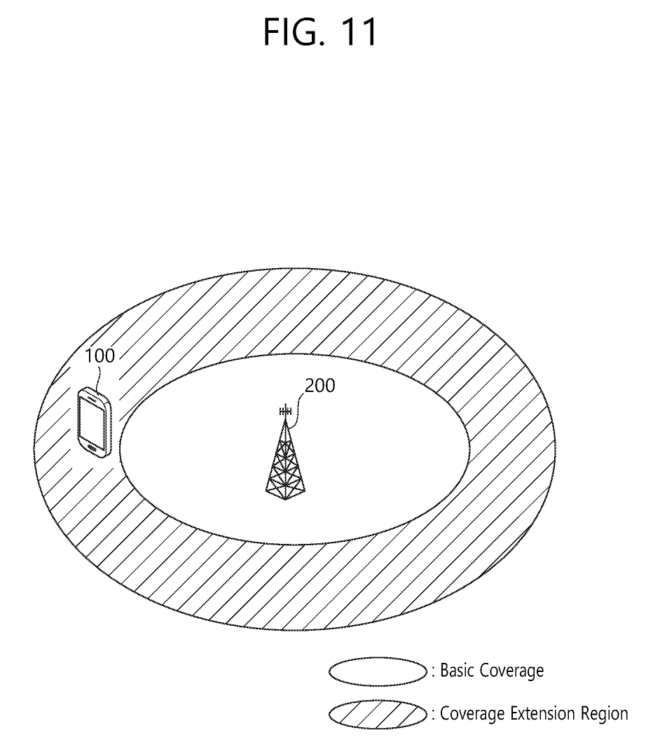

FIG. 11 is an example of cell coverage extension or enhancement for an IoT device.

Recently, to extend or enhance cell coverage of the eNB 200 for the IoT UE 100 is taken into consideration, and various schemes for the cell coverage extension or enhancement are being discussed.

However, if coverage of the cell is extended or enhanced, when the eNB 200 transmits a downlink channel to the IoT UE 100 located in the coverage extension (CE) or coverage enhancement (CE) area, the corresponding IoT UE 100 has a difficulty in receiving the downlink channel.

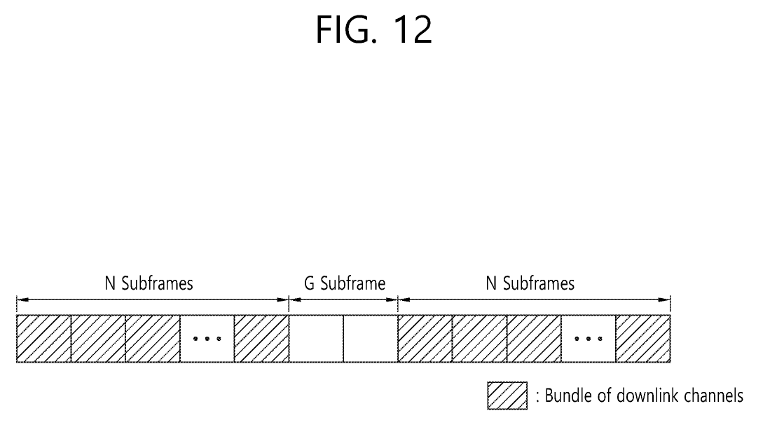

FIG. 12 is an exemplary diagram showing an example of bundle transmission.

Referring to FIG. 12, in order to solve a problem, such as that described above, the eNB 200 may repeatedly transmit a downlink channel to the IoT UE 100, located in the coverage-extended or coverage-enhanced area, through a plurality of subframes (e.g., N subframes). Physical channels repeated and transmitted on a plurality of subframes as described above are called a bundle of channels.

Furthermore, the IoT UE 100 may receive a bundle of the downlink channels through the plurality of subframes and performs decoding based on some of or the entire bundle, thereby being capable of improving a decoding success rate.

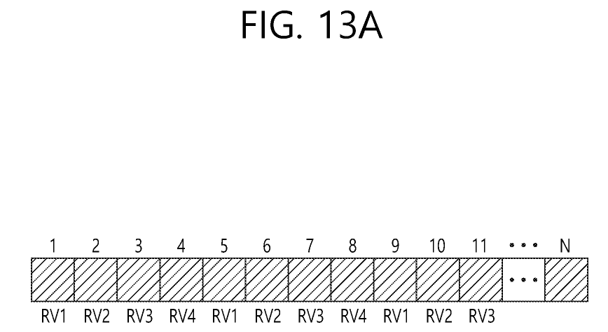

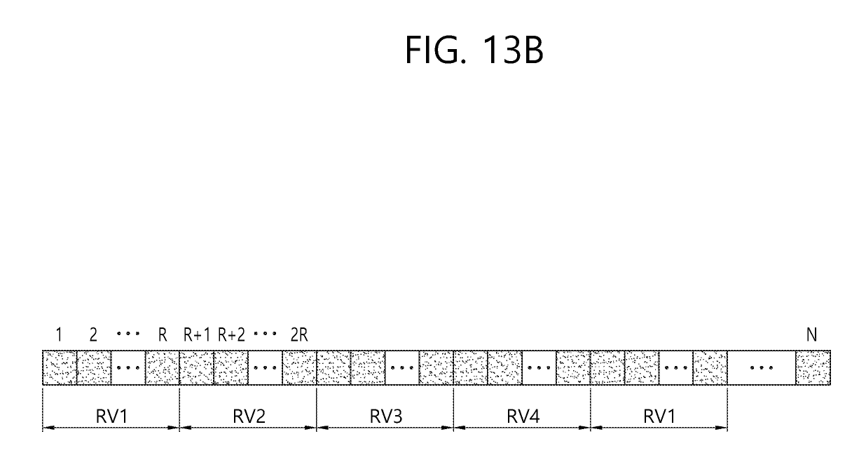

FIGS. 13a and 13b are exemplary diagrams showing some examples of a redundancy version (RV) for bundle transmission.

As shown in FIG. 13a, in the value of the redundancy version (RV) of a physical channel repeatedly transmitted in a plurality of subframes, a plurality of the RV values may be cyclically applied to the respective subframes.

Furthermore, as shown in FIG. 13b, in the RV value of a physical channel repeatedly applied to a plurality of subframes, a plurality of the RV values may be cyclically applied every R subframes. In this case, the number of subframes R to which the same RV value is applied may be a value that has been previously defined and fixed or a value set by an eNB.

If the same RV value has been applied to a plurality of subframes as described above, data having the same bits is transmitted through the physical channel of a corresponding subframe. In this case, if the data transmitted through the corresponding physical channel is together combined and used to receive data, the decoding success rate of the received data can be improved. To this end, in a DMRS-based data transmission environment, the same precoding needs to be applied while the plurality of subframes is transmitted.

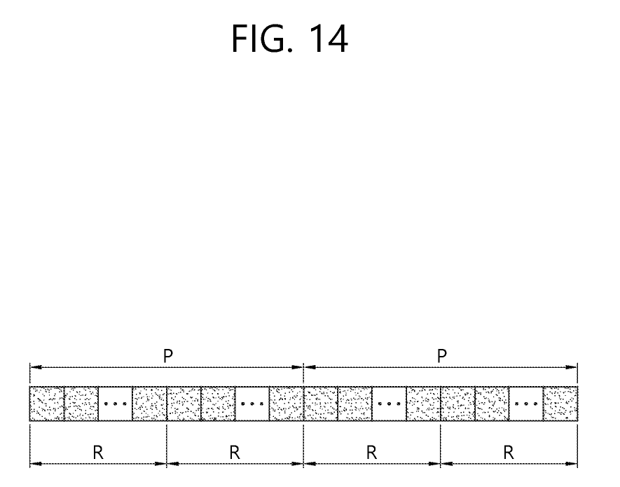

FIG. 14 is an exemplary diagram showing an example in which the same precoding has been applied while a plurality of subframes is transmitted.

As shown in FIG. 14, the same precoding may be applied while P subframes are transmitted. In this case, the value P may be a previously defined and fixed value or may be a value set by an eNB.

More specifically, if the RV value combines the data of the same subframe and performs modulation, data reception performance can be improved. Furthermore, in order to obtain a precoding diversity effect, a value of P, that is, the number of subframes to which the same precoding, is applied and a value of R, that is, the number of subframes to which the same RV value, may be identically set.

If the value of P, that is, the number of subframes to which the same precoding is applied, is not set by an eNB, but only the value of R, that is, the number of subframes to which the same RV value is applied, is set by a UE, the UE may determine that the same precoding has been applied within a bundle of contiguous subframes to which the same RV value is applied. Furthermore, assuming that the cycle in which different RV values are repeated or the interval between subframes to which the same RV value is applied again is an RV cycling period, a UE may determine that the same precoding has been applied during one RV cycling period (or a period corresponding to a multiple of an RV cycling period).

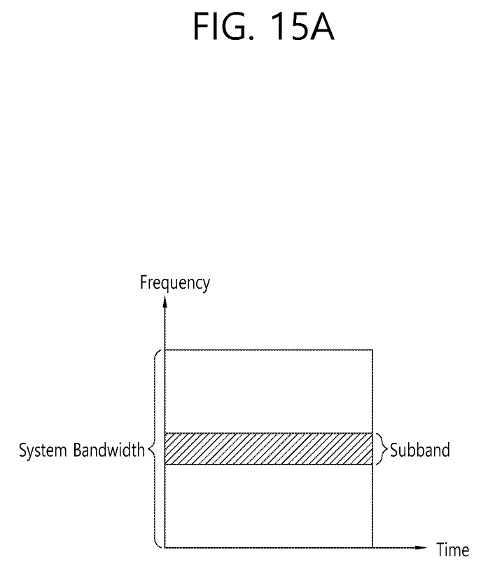

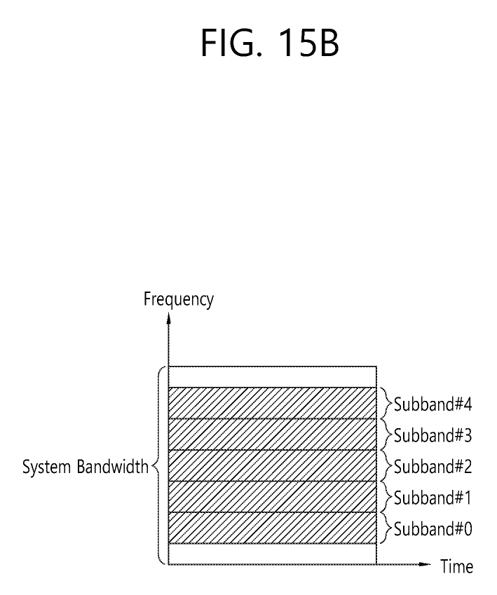

FIGS. 15a and 15b are exemplary diagrams showing some examples of a subband in which an IoT UE operates.

As a scheme for the low cost of an IoT UE, the IoT UE may use only some subbands regardless of the system bandwidth of a cell.

In this case, as shown in FIG. 15a, the region of a subband in which the IoT UE operates may be located in the center region of the system bandwidth of the cell. Furthermore, for the purpose of multiplexing between IoT UEs within a subframe, as shown in FIG. 15b, some subbands may be included in one subframe and a plurality of the IoT UEs may use different subbands.

In order to achieve the low complexity and low cost of an IoT UE, a low PAPR is essential. In the NB-IoT, a factor that increases the PAPR chiefly includes two factors. The first is a phenomenon in which zero-crossing is generated and a constant envelope is broken due to a phase difference between symbols. Furthermore, the second is the generation of fluctuation within one symbol attributable to a reinforcement and offset between signals mapped to different subcarriers in a multiple carrier system.

From among them, the generation of fluctuation within a symbol can be solved by taking into consideration single-tone transmission in which only one resource block (RB) is transmitted in one subcarrier in the NB-IoT. In the case of the single-tone transmission, the PAPR can be reduced because the characteristics of a single carrier are satisfied and thus a constant envelope is maintained within one symbol. Furthermore, the single-tone transmission may also help the restriction of the number of subcarriers and coverage extension.

However, the generation of zero-crossing attributable to a phase difference between symbols cannot be solved by only the single-tone transmission. Furthermore, such a problem may be partially improved through a method of applying a phase rotation scheme between symbols. Accordingly, this specification proposes some methods for reducing the PAPR in an NB-IoT system into which the single-tone transmission is taken into consideration. The methods proposed by this specification have been described based on a PDSCH or PUSCH in the NB-IoT system, for convenience sake, but is not limited thereto and may be applied to the transmission of uplink/downlink data/control channels.

<Symbol Repetition>

As described above, in order to support coverage extension or coverage enhancement, an NB-IoT system takes into consideration the repetition transmission of data. In this case, in order to effectively perform the combining of repeatedly transmitted data, it is preferred that resource elements (REs) in which the same symbol is transmitted experience a similar channel environment. More specifically, if one transport block (TB) is mapped within one subframe and the transmission of the corresponding transport block is repeated for each subframe, the same symbol is distributed to a plurality of subframes. In this case, since a channel environment between the subframes may be different, an environment experienced by each symbol may be different when data is combined. Accordingly, if a repeatedly transmitted symbol is transmitted through a neighboring resource, it may be more effective in the combining of data.

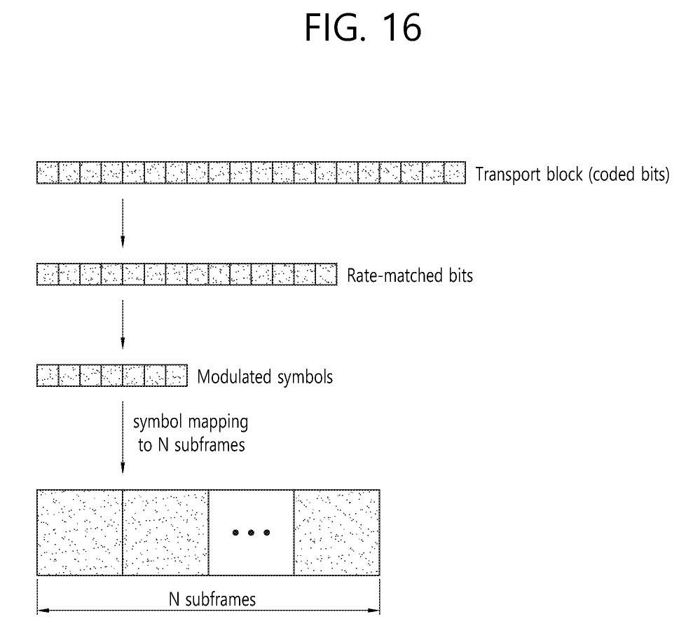

FIG. 16 is an exemplary diagram showing an example of a process in which a transport block is mapped to resources.

In this specification, as shown in FIG. 16, it is assumed that one transport block (TB) experiences rate-matching and modulation processes and the TB is mapped to a resource forming a total of N subframes and transmitted. In this case, the transport block (TB) may mean channel-coded bits that have experienced the addition of cyclical redundancy check (CRC) to data transmitted by a higher layer, code block segmentation, the addition of code block CRC, and a channel coding process.

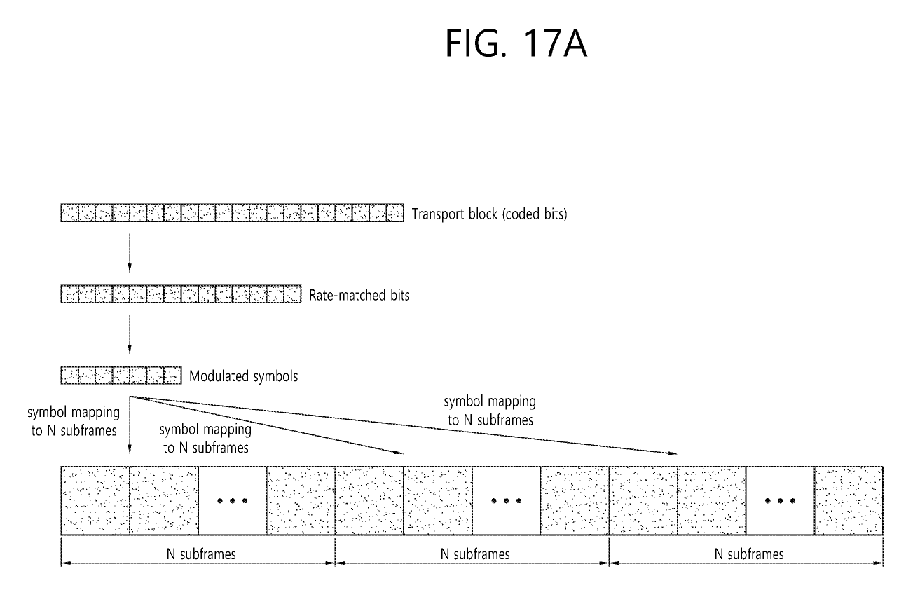

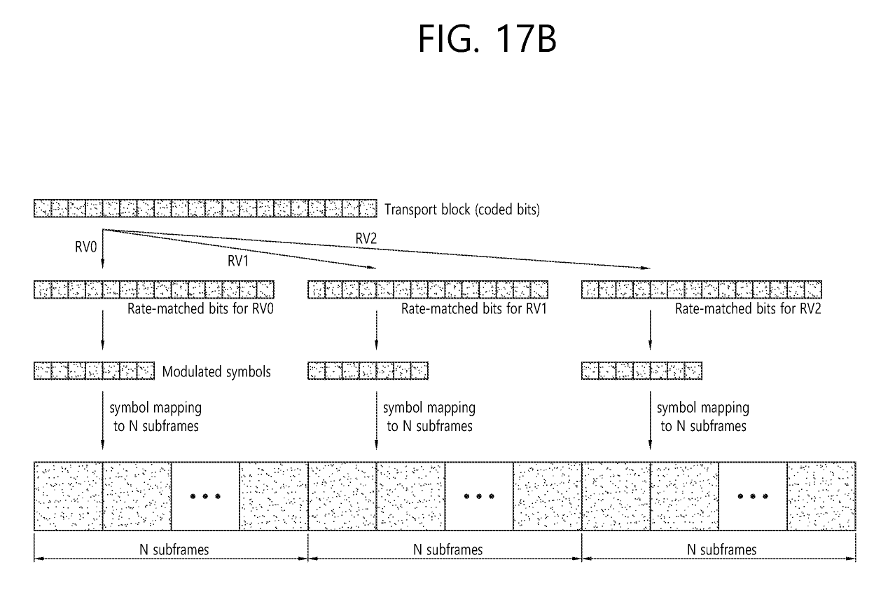

FIGS. 17a and 17b are exemplary diagrams showing some examples of a process in which N subframes are repeated and transmitted N times.

As shown in FIGS. 17a and 17b, in one transport block (TB), N subframes may be repeated R times and transmitted through a total of N×R subframes.

In this case, as shown in FIG. 17a, a specific symbol sequence may be mapped and transmitted within the N subframes, and the same symbol sequence may be mapped and transmitted within next N subframes. Furthermore, a symbol sequence that has been rate-matched by a specific RV value and generated may be mapped and transmitted within the N subframes, and a symbol sequence that has been rate-matched by a specific RV value and generated may be mapped and transmitted within next N subframes. That is, symbol sequences that have been rate-matched by the same RV value and generated may be mapped and transmitted every N subframes.

Furthermore, as shown in FIG. 17b, a symbol sequence that has been rate-matched by a first RV value and generated may be mapped and transmitted in first N subframes, and a symbol sequence that has been rate-matched by a second RV value and generated may be mapped and transmitted in next N subframes. That is, a symbol sequence that has been rate-matched by a different RV value and generated may be mapped and transmitted every N subframes.

Hereinafter, a method of repeatedly transmitting a symbol sequence that is rate-matched by a specific RV value and generated within N subframes is described.

In a conventional LTE system, a minimum unit forming repetition mapping is a subframe unit. However, this specification proposes a method of improving PAPR performance by performing repetition mapping in a symbol unit. Hereinafter, for convenience of description, a single bundle in which the same symbol is contiguously repeated and disposed is defined as a symbol repetition set. The PAPR attributable to a phase difference between symbols can be reduced because the same symbol repeatedly appears while a symbol repetition set is maintained. In this case, the repetition of the symbol may be applied to all of data, such as a data symbol and a reference signal symbol. A method of configuring a symbol repetition set may be variously different depending on the requirements of a system. The type of symbol repetition set capable of various configurations may support only one type or may support several types at the same time depending on the system. Furthermore, the type of symbol repetition set may be determined based on a previously determined and fixed value, but may be determined based on a value set by an eNB and transferred to an IoT UE.

1. Type 1 of Symbol Repetition Set

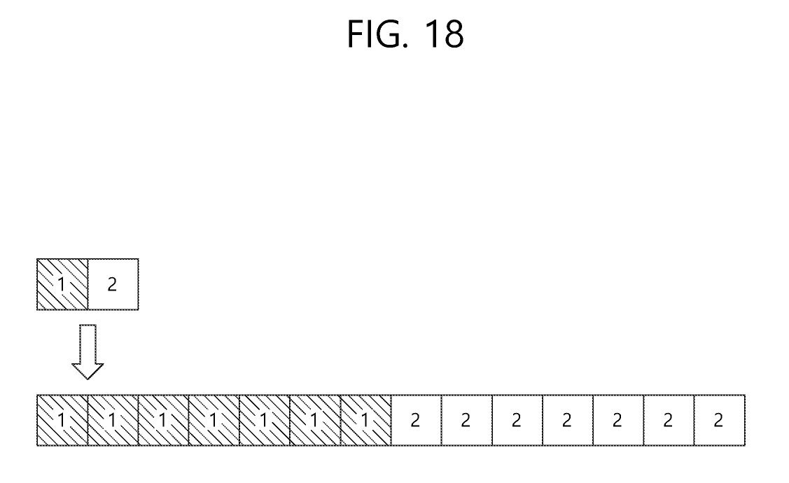

FIG. 18 is an exemplary diagram showing an example of symbols allocated according to type 1 of a symbol repetition set.

As a basic method of performing the repetition of a symbol unit, all of repeated symbols may gather to form a single symbol repetition set. If an N-times repeated transmission signal is taken into consideration, the same N contiguous same symbols may gather to form one symbol repetition set, and the formed symbol repetition set may be sequentially disposed. The size of N may be determined in various ways depending on the requirements of a system and may be set different sizes for each datum. If the size of a symbol repetition set is greater than the size of a subframe (or slot), the symbol repetition set may be divided into several subframes (or slots) in a subframe (or slot) unit and disposed. Furthermore, one subframe (or slot) may be shared by several symbol repetition sets.

For example, as shown in FIG. 18, in a system to which 7-times repetition is applied, a symbol repetition set may be configured in a form in which each symbol is repeatedly allocated to contiguous 7 symbols. Furthermore, the configured symbol repetition sets may be sequentially disposed according to the sequence of data configured in a transport block.

2. Type 2 of Symbol Repetition Set

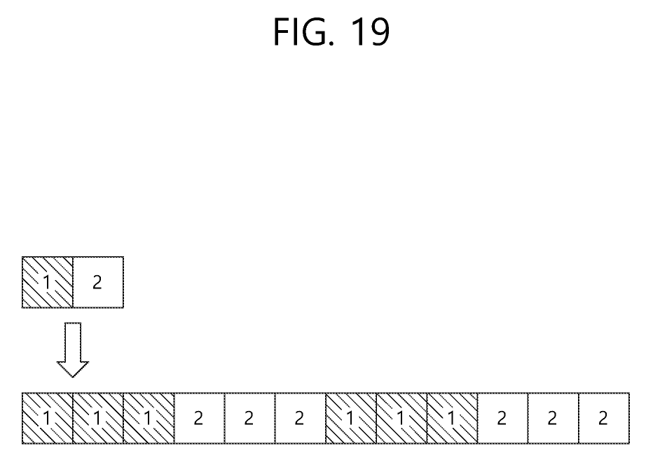

FIG. 19 is an exemplary diagram showing an example of symbols allocated according to type 2 of symbol repetition set.

As a next method of performing a symbol unit repetition, a symbol repetition set configured according to type 1 of symbol repetition set may be divided into a plurality of subsets and arranged. type 2 of symbol repetition set may be required in a design process into which the structural characteristics of a frame taken into consideration in a system, a diversity gain or a special symbol whose location is fixed are taken into consideration. In a system that requires N symbol repetitions, if a symbol repetition set is divided into M subsets and arranged, symbols repeated in the M subsets may be divided and allocated so that N1+N2+ . . . , +NM=N is satisfied, and the divided symbol repetition sets may be arranged according to a predetermined resource mapping rule. In this case, the size of N and the size of M may be variously selected depending on conditions required for a system, and may have different values depending on a data symbol.

For example, as shown in FIG. 19, in a system to which an (N=6)-times repetition is applied, if a symbol repetition set is configured by dividing it into (M=2) subsets, a structure in which the repetition is performed N1 times and N2 times through N1 and N2 that satisfy N1+N2=N may be taken into consideration. In this case, the size or number in which the symbol repetition set is divided may be adjusted according to circumstances.

3. Type 3 of Symbol Repetition Set

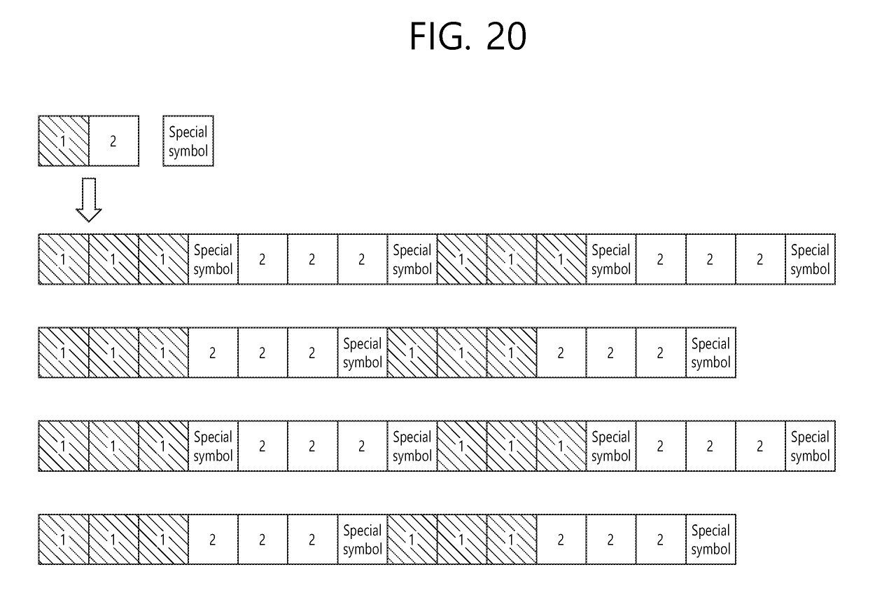

FIG. 20 is an exemplary diagram showing an example of symbols allocated according to type 3 of symbol repetition set.

As a next method of performing a symbol unit repetition, a case where symbols of a specific purpose do not comply with the repetition pattern of other symbols, but must be allocated to fixed locations within a frame according to the requirements of a system is taken into consideration. Other symbols that must form a symbol repetition set are allocated to the locations of symbols other than previously reserved locations due to the fixed locations of the specific symbols. For example, if a DMRS complies with a conventional LTE system, a corresponding location cannot be used as a pattern for a repetition because it has a previously agreed location. Such a specific symbol may be a single symbol, and one symbol repetition set may act as a special symbol. Furthermore, the number of times of the repetitions of a symbol may be applied to all of symbols identically or differently. The location of a specific symbol or the size of a symbol repetition set may be determined depending on the requirements of a system.

type 3 of symbol repetition set may be configured to have a structure in which a special symbol is located between a plurality of symbol repetition sets or within one symbol repetition set, that is, a modified form of type 1 or type 2, by taking into consideration such a constraint condition. FIG. 20 shows some examples in which a plurality of symbol repetition sets and special symbols are disposed.

<Phase Rotation Scheme>

A phase rotation scheme may be used to prevent a PAPR increase phenomenon according to a phase change between symbols. If a phase between symbols is greatly changed, the constant envelope of a signal is not maintained, and in severe cases, zero-crossing is generated and thus the PAPR is greatly deteriorated. In order to prevent such problems, the phase rotation scheme reduces the interval in which a phase change may occur between symbols and prevents the generation of zero-crossing by changing a constellation point for each symbol.

In the configuration of the symbol repetition set proposed by this specification, the same symbol is allocated so that it is contiguously located. Accordingly, a phase change attributable to a change of data is not generated within a symbol repetition set in which N symbols are contiguously disposed. If the phase rotation scheme is applied to the period in which a phase change is not generated as described above, the PAPR may be deteriorated because the characteristics of a constant envelope are deteriorated. Alternatively, a phase may be changed at the boundary where the repetition of a first symbol ends and the repetition of second symbols starts. Accordingly, a proper compensation scheme is necessary to improve performance of the PAPR.

This specification proposes a phase rotation scheme for reducing the deterioration of the PAPR attributable to a phase change between symbol repetition sets while maintaining a maximum constant envelope characteristic of the symbol repetition set. In the phase rotation scheme proposed by this specification, in order to reduce the deterioration of the PAPR, a phase rotation is not performed in the period in which a symbol repetition is maintained, and a phase change smoother than a case where a phase change is generated may be generated at the boundary of symbol repetition sets. Such a phase rotation scheme may be applied along with a method of configuring a symbol repetition set, such as that described above, but may be independently applied.

1. Type A of Phase Rotation

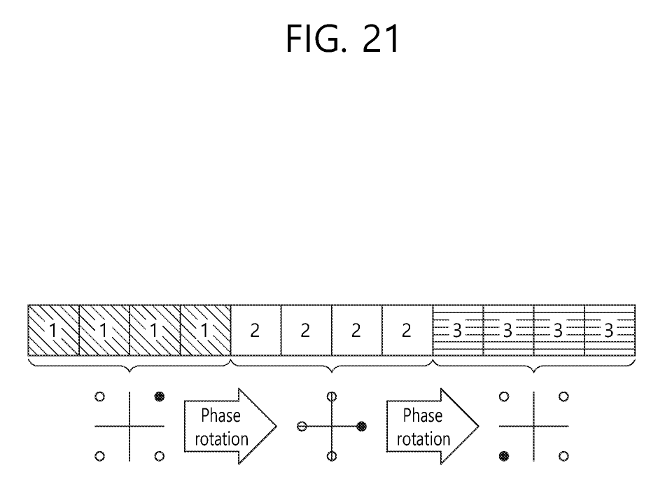

FIG. 21 is an exemplary diagram showing an example of a phase rotated according to type A of phase rotation.

The phase rotation scheme does not need to be performed because the phase of input data is not changed while the repetition of a symbol is maintained as described above. Accordingly, as shown in FIG. 21, a phase rotation is not performed and a phase remains intact in the period in which the repetition of a symbol is maintained. Furthermore, a phase rotation is performed only in the boundary at which the repetition of a symbol ends and the repetition of a new symbol starts. A point at which a phase rotation is generated may be applied even in type 3 of symbol repetition set if there is a special symbol between symbol repetition sets. In this case, the special symbol may be a single symbol, and a plurality of symbols may be bundled as a set to form the special symbol.

2. Type B of Phase Rotation

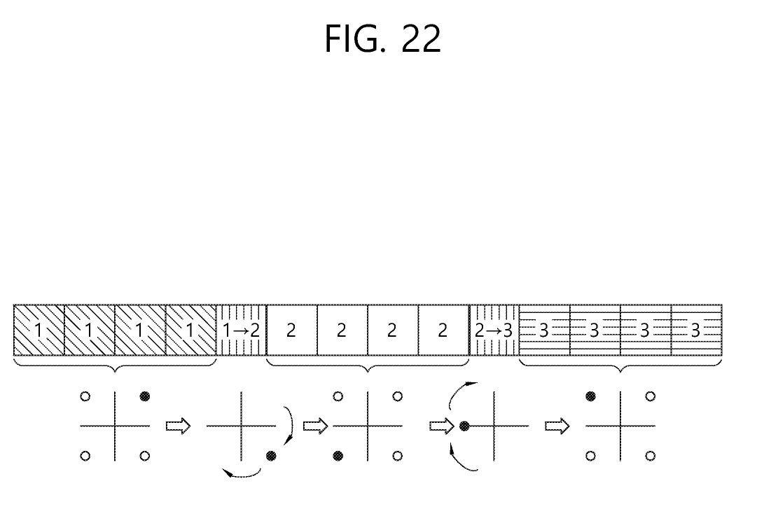

FIG. 22 is an exemplary diagram showing an example of a phase rotated according to type B of phase rotation.

In type B of phase rotation, an additional symbol may be inserted in a phase rotation process in order to make a phase change smoother, as shown in FIG. 22. Even in this case, as in type A of phase rotation, a phase rotation is not performed while the repetition of a symbol is maintained. Accordingly, while the repetition of a symbol is maintained, the same constellation point is shared. Furthermore, a phase smoothing symbol is inserted between symbol repetition sets in order to prevent a sudden phase change attributable to the execution of a phase rotation in the boundary where the repetition of a symbol ends and the repetition of a new symbol starts.

The phase of the phase smoothing symbol may be determined to have a middle value of phases that determines the constellation point of two neighbor symbol repetition sets. Accordingly, a maximum size of a phase change that may occur between symbols may be π/2. Accordingly, the generation of zero-crossing can be prevented and the size of the fluctuation of an envelope can be reduced because the size of a phase change is reduced. Furthermore, if the size of a phase change that may occur between symbols can be further reduced, the phase of a phase smoothing symbol may be determined to have a value different from a middle value. For example, if the size of a phase change or the location of a phase has been defined to be fixed depending on the requirements of a system, a determination of a phase based on a middle value may not be the nest in reducing the size of the phase change. Accordingly, in such a case, it may be preferred that the phase of a phase smoothing symbol is determined to have a value different from a middle value. For example, it is assumed that if symbol repetition of PUSCH data using QPSK modulation is taken into consideration, two neighbor symbol repetition sets use phase modulations of π/2 and 3 π/2, respectively. In this case, if a phase rotation is not used, a phase change of 7E is generated. If type A of phase rotation is applied, a phase rotation of 3π/4 is generated. In contrast, if type B of phase rotation is applied, a phase rotation of π/4 is generated, and a change of a phase is relatively small.

3. Type C of Phase Rotation

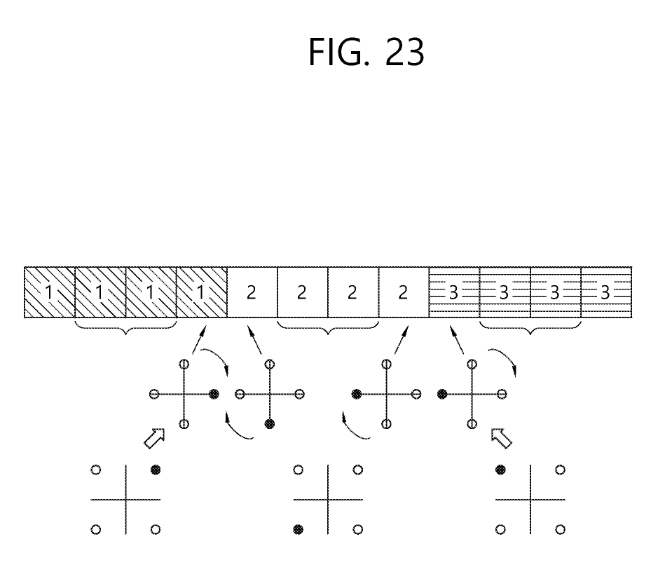

FIG. 23 is an exemplary diagram showing an example of a phase rotated according to the phase rotation type C.

In type C of phase rotation, a phase rotation is applied to symbols located at the first and last of a symbol repetition set, but the phase rotation is not applied to other symbols. In type C of phase rotation, unlike in type B of phase rotation, an additional symbol is not required. The period in which a PAPR increase attributable to a phase difference between symbols is generated is a symbol located at the edge between two contiguous symbol repetition sets. That is, in a first symbol repetition set and a second symbol repetition set that are contiguous, the PAPR is increased due to a phase difference between a symbol located at the last of the first symbol repetition set and a symbol located at the first of the second symbol repetition set.

Accordingly, in type C of phase rotation, in a plurality of contiguous symbol repetition sets, a phase rotation is performed on the phases of symbols located at the first and last of each symbol repetition set by taking into consideration the phase of a previous symbol or next symbol. In this case, the phase rotation of a symbol located at the edge of each symbol repetition set may be determined depending on the phase of a neighbor symbol repetition set.

In type C of phase rotation, a symbol on which a phase rotation is performed may be one or two or more symbols of symbols included in one symbol repetition set. Specifically, if a phase rotation is performed on one symbol, a symbol located at one of both edges of a symbol repetition set may be selected and the phase rotation may be performed on the selected symbol. Furthermore, if a phase rotation is performed on two symbols, the phase rotation may be performed on two symbols located at both edges of a symbol repetition set or two symbols contiguously located at one edge. For example, as shown in FIG. 23, a phase rotation may be performed on two symbols located at both edges of a symbol repetition set.

4. Type D of Phase Rotation

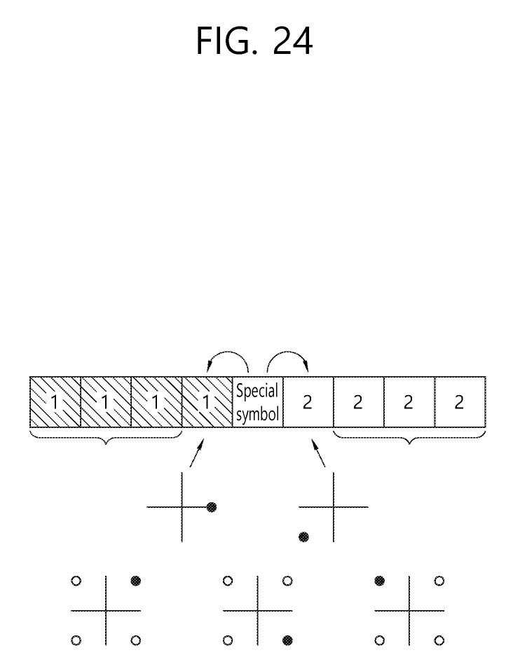

FIG. 24 is an exemplary diagram showing an example of a phase rotated according to type D of phase rotation.

In type D of phase rotation, a phase rotation when a special symbol is present is taken into consideration. Some of special symbols may not be randomly modified for a phase rotation in view of their characteristic. For example, in the case of a DMRS, a transmission stage and a reception stage must recognize the DMRS identically because the location and phase of a symbol are constantly fixed depending on its purpose, and the transmission stage should not randomly change the DMRS. Accordingly, a case where a special symbol having such characteristics is present needs to be taken into consideration.

Type D of phase rotation is a method for taking into consideration a special symbol and also making a phase change smoother. More specifically, as shown in FIG. 24, in type D of phase rotation, the phases of symbols adjacent each other on the left and right of a special symbol are changed based on location and phase information of the special symbol. In this case, the original phase of a symbol that neighbors the special symbol and that is located at the edge of a symbol repetition set is changed, and other symbols included in the corresponding symbol repetition set maintain their original phases. Specifically, the phases of the symbols that neighbor the left and right of the special symbol may be rotated so that they have a middle value of the phase of the symbol repetition set to which the corresponding symbol belongs and the phase of the special symbol. Furthermore, if the size of a phase change that may occur between symbols can be further reduced, the phases of the symbols that neighbor the left and right of the special symbol may be rotated based on a value different from a middle value. For example, if the size of a phase change or the location of a phase is defined to be fixed depending on the requirements of a system, a phase rotation according to a middle value may not be the best in reducing the size of a phase change. Accordingly, in such a case, it may be preferred that the phases of symbols that neighbor the left and right of a special symbol are rotated based on a value different from the middle value.

In such a structure, if the decoding of a special symbol is first performed, the decoding of symbols that neighbor the left and right of the special symbol and whose phases have been rotated may be detected based on information of the decoded special symbol. For example, if a DMRS is used as a special symbol, the corresponding DMRS may be first decoded for coherent detection, and phase rotation information of symbols neighboring the left and right of the DMRS may be compensated for based on information of the decoded DMRS.

The reference constellation phases of a special symbol and a common data symbol may be the same, and a reference constellation phase whose phase has been rotated may be used. As described above, if a phase rotation is additionally performed by taking into consideration a special symbol, complexity may be increased, but the phase change can be performed more smoothly.

<Modulation Scheme for Type C of Phase Rotation>

In the case of type C of phase rotation, phase rotations of various forms may be taken into consideration. In this specification, some phase rotation methods for type C of phase rotation are described, and modulation and demodulation methods for type C of phase rotation are described.

1. Modulation Method 1 for Type C of Phase Rotation

For a phase rotation operation for type C of phase rotation, constellation mapping may be performed by averaging the phase values of three symbols.

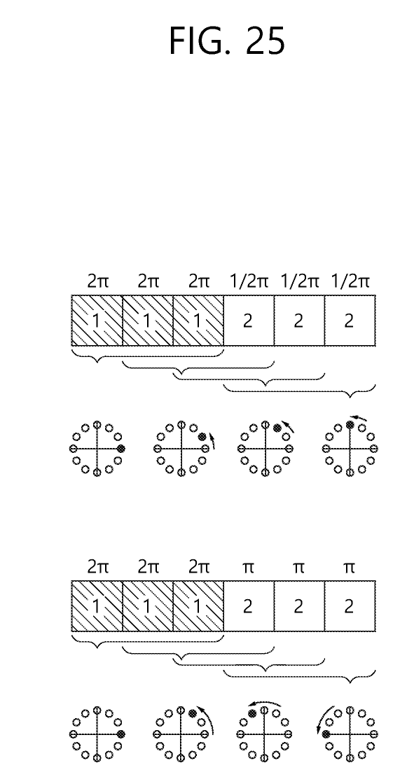

FIG. 25 is an exemplary diagram showing an example of a phase rotated by taking into consideration quadrature phase shift keying (QPSK) modulation according to the modulation method 1.

First, information to be allocated to each symbol is generated by performing M-phase shift keying (M-PSK) modulation on an input bit. In this case, the generated M-PSK modulation result value is not immediately used, and the final constellation mapping value may be determined by taking into consideration the phase value of M-PSK modulation to be allocated to symbols that neighbor back and forth. More specifically, it is assumed that the phase value of an M-PSK modulation result corresponding to an n-th symbol with respect to a symbol index n is φn. In this case, the final phase value constellation-mapped to the n-th symbol may be determined to be an average value obtained by adding the M-PSK modulation phase value of the n-th symbol and the M-PSK modulation phase values of the two symbols neighboring back and forth and then dividing the added result value by 3. Such a method is expressed in the form of an equation as follows.

θₙ=(φₙ₋₁+φₙ+φₙ₊₁)/3 [Equation 1]

For example, if QPSK modulation is taken into consideration, the phase rotation process according to Equation 1 is shown in FIG. 25.

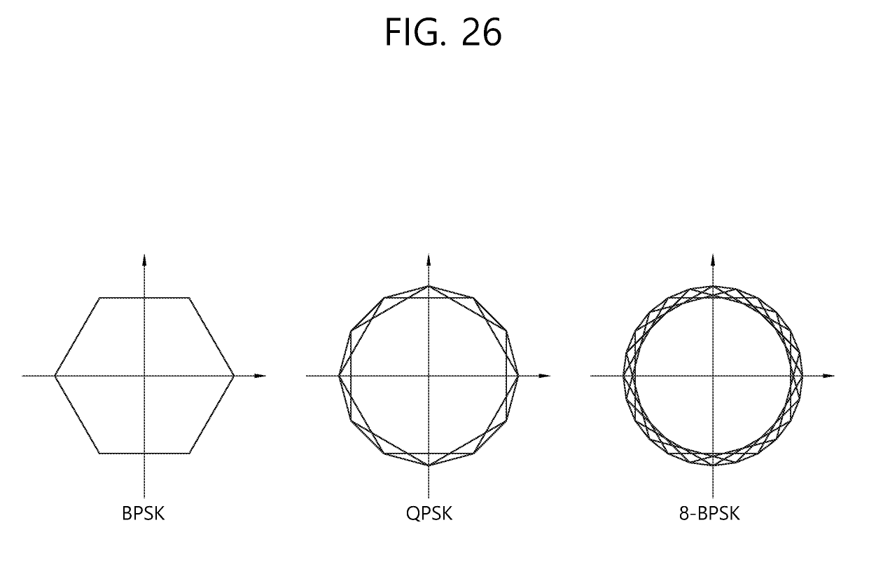

FIG. 26 is an exemplary diagram showing all of paths which may occur due to a phase change into which binary PSK (BPSK), QPSK and 8-BPSK modulation are taken into consideration according to the modulation method 1.

If the modulation method 1 described above is applied, a constellation form may appear in a form close to a constant envelope because the size of a phase change is relatively reduced. As shown in FIG. 26, more results in which QPSK modulation is taken into consideration than results in which BPSK modulation is taken into consideration may be close to a constant envelope, and more results in which 8-BPSK modulation is taken into consideration than results in which QPSK modulation is taken into consideration may be close to a constant envelope.

2. Modulation Method 2 for Type C of Phase Rotation

For a phase rotation operation for type C of phase rotation, constellation mapping may be performed by averaging the phase values of two symbols.

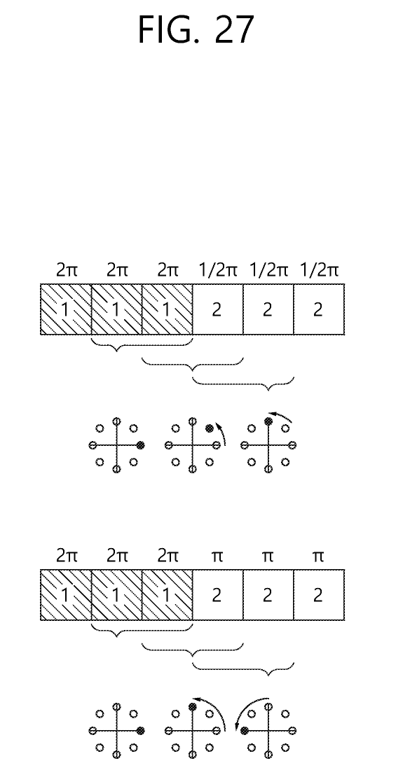

FIG. 27 is an exemplary diagram showing an example of a phase rotated into which QPSK modulation is taken into consideration according to the modulation method 2.

First, information to be allocated to each symbol is generated by performing M-phase shift keying (M-PSK) modulation on an input bit. In this case, the generated M-PSK modulation result values are not immediately used, and the final constellation mapping value may be determined by taking into consideration one of the phase values of M-PSK modulation to be allocated to symbols that neighbor back and forth. More specifically, it is assumed that the phase value of an M-PSK modulation result corresponding to an n-th symbol with respect to a symbol index n is φn. In this case, the final phase value constellation-mapped to the n-th symbol may be determined to be an average value obtained by adding the M-PSK modulation phase value of the n-th symbol and one of the M-PSK modulation phase values of the two symbols neighboring back and forth and then dividing the added result value by 2. Such a method is expressed in the form of an equation as follows.

θₙ=(φₙ₋₁+φₙ)/2 [Equation 2]

For example, if QPSK modulation is taken into consideration, the phase rotation process according to Equation 2 is shown in FIG. 27. In the case of QPSK modulation, a phase change of up to ½π may be generated. As shown in FIG. 27, in a symbol on which a phase rotation is performed, the constellation point of a one-step higher modulation sequence is used in the final constellation mapping. In contrast, in symbols on which a phase rotation is not performed, a constellation point according to the original modulation sequence is used without any change.

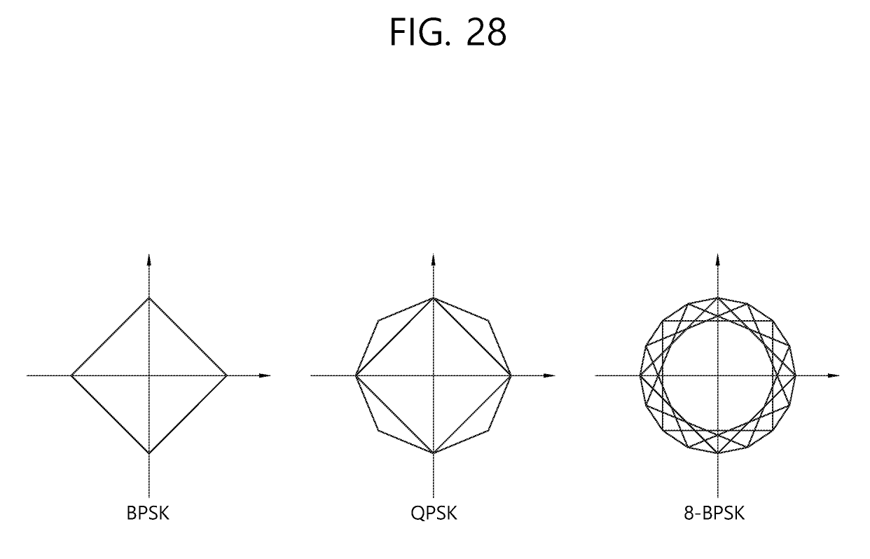

FIG. 28 is an exemplary diagram showing all of paths which may occur due to a phase change into which BPSK, QPSK and 8-BPSK modulation are taken into consideration according to the modulation method 2.

If the modulation method 2 described above is applied, a constellation form may appear in a form close to a constant envelope because the size of a phase change is relatively reduced. As shown in FIG. 28, more results in which QPSK modulation is taken into consideration than results in which BPSK modulation is taken into consideration may be close to a constant envelope, and more results in which 8-BPSK modulation is taken into consideration than results in which QPSK modulation is taken into consideration may be close to a constant envelope.

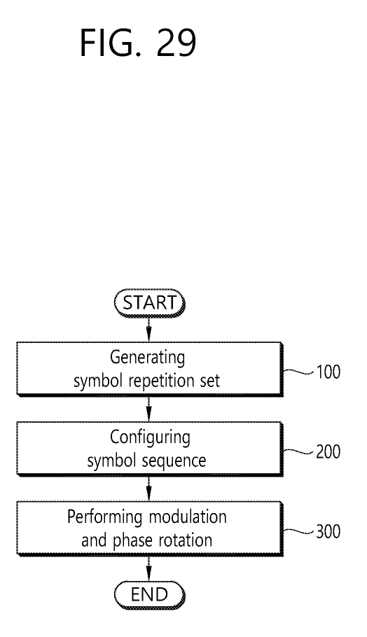

FIG. 29 is a flowchart illustrating a symbol mapping method for a reduction of the PAPR according to this specification.

Referring to FIG. 29, an IoT UE generates one or more symbol repetition sets by contiguously repeatedly disposing data symbols to be transmitted (S100). For example, if data symbols to be transmitted include a first symbol and a second symbol, the IoT UE may generate a first symbol sequence (i.e., a first symbol repetition set) in which only the first symbol of the data symbols to be transmitted is contiguously disposed, and may generate a second symbol sequence (i.e., a second symbol repetition set) in which only the second symbol is contiguously disposed.

The IoT UE configures a symbol sequence to be transmitted by allocating the one or more symbol repetition sets (S200). More specifically, the IoT UE may configure the symbol sequence by segmenting each of the one or more symbol repetition sets into a plurality of subsets and allocating the plurality of segmented subsets in accordance with a predetermined resource mapping rule.

Furthermore, if the symbol repetition set includes a special symbol whose location has been previously reserved, the IoT UE may determine the size of the plurality of subsets based on the location of the special symbol and segment each of the one or more symbol repetition sets into a plurality of subsets based on the determined size of the subsets.

The IoT UE performs modulation and a phase rotation on the configured symbol sequence (S300). More specifically, the IoT UE performs modulation on the symbol sequence, but performs a phase rotation at the boundary where a symbol repetition sequence is changed and does not perform a phase rotation in the period in which the repetition of the same symbol is maintained within a symbol repetition sequence.

That is, the IoT UE may perform a phase rotation at the boundary in which the first symbol repetition set changes to the second symbol repetition set. Specifically, the IoT UE inserts an additional symbol into the boundary of the first symbol repetition set and the second symbol repetition set, but may determine the phase of the additional symbol so that it becomes has a middle value of the phase of the first symbol repetition set and the phase of the second symbol repetition set. Furthermore, the IoT UE may rotate the phase of a data symbol located the last of the first symbol repetition set based on the phase of a data symbol located at the first of the second symbol repetition set. Furthermore, the IoT UE may rotate the phase of the data symbol located at the first of the second symbol repetition set based on the rotated phase of the data symbol located at the last of the first symbol repetition set.

If the symbol repetition set includes a special symbol whose phase has been previously reserved, the IoT UE may rotate the phase of a data symbol to be disposed to neighbor the special symbol based on the phase of the special symbol. More specifically, the IoT UE may rotate the phase of a third symbol located right before the special symbol so that it becomes a middle value of the phase of a symbol repetition set to which the third symbol belongs and the phase of the special symbol. Furthermore, the IoT UE may rotate the phase of a fourth symbol located right after the special symbol so that it becomes a middle value of the phase of a symbol repetition set to which the fourth symbol belongs and the phase of the special symbol.

Furthermore, the IoT UE determines the phase of a data symbol included in the data sequence, but may determine the phase of the data symbol by taking into consideration the phases of two data symbols located right before and right after the data symbol. More specifically, the IoT UE may determine a value, obtained by adding the phase value of a first symbol included in the data sequence, the phase of a third symbol value located right before the first symbol, and the phase value of a fourth symbol located right after the first data symbol and then dividing the added value by 3, to be the phase value of the first symbol. Furthermore, the IoT UE may determine a value, obtained by adding the phase value of the first symbol included in the data sequence and one of a phase value of the third symbol located right before the first symbol and the phase value of the fourth symbol located right after the first data symbol and then dividing the added value by 2, to be the phase value of the first symbol.

The embodiments of the present invention described so far may be implemented through various means. For example, the embodiments of the present invention may be implemented by hardware, firmware, software or a combination of them. Specifically, this is described with reference to the drawing.

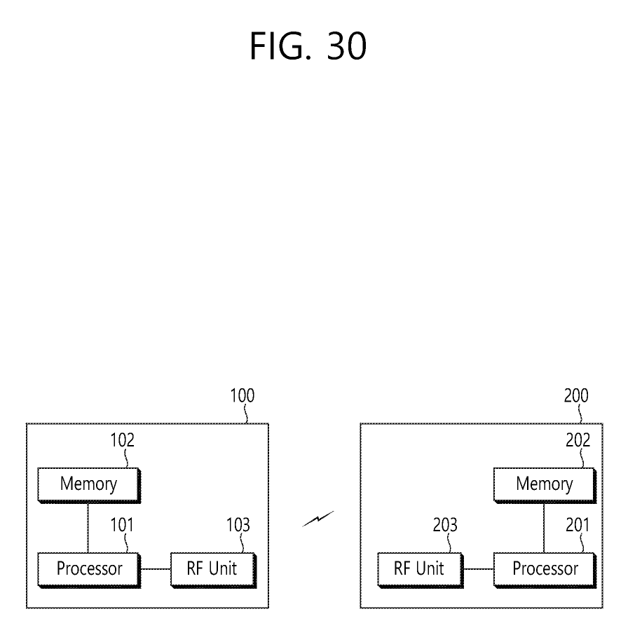

FIG. 30 is a block diagram showing a wireless communication system which implements the present invention.

Referring to FIG. 30, the eNB 200 includes a processor 201, memory 202, and a radio frequency (RF) unit 203. The memory 202 is connected to the processor 201 and stores various types of information for driving the processor 201. The RF unit 203 is connected to the processor 201 and transmits and/receives a wireless signal. The processor 201 implements the proposed functions, procedures and/or methods. The operation of the base station 200 according to the embodiment may be implemented by the processor 201.

The IoT UE 100 includes a processor 101, memory 102, and an RF unit 103. The memory 102 is connected to the processor 101 and stores various types of information for driving the processor 101. The RF unit 103 is connected to the processor 101 and transmits/receives a radio signal. The processor 101 implements the proposed functions, procedures and/or methods.

The processor may include an application-specific integrated circuit (ASIC), other chipsets, a logic circuit and/or a data processor. The memory may include read-only memory (ROM), random access memory (RAM), flash memory, a memory card, a storage medium and/or other storage devices. The RF unit may include a baseband circuit for processing an RF signal. If the embodiment is implemented, the above scheme may be implemented by a module (procedure, function, etc.) for performing the functions. The module is stored in the memory and may be implemented by the processor. The memory may be located inside or outside the processor, and may be connected to the processor through various known means.

In the above exemplary system, although the methods have been described based on the flowchart including a series of the steps or blocks, the present invention is limited to the sequence of the steps. Some of the steps may be generated in order different from or simultaneously with other steps. Furthermore, it is well known to those skilled in the art that the steps included in the flowchart are not exclusive, but include other steps or one or more steps in the flowchart may be deleted without influencing the scope of the present invention.

What is claimed is:

1. A method of mapping a data symbol in a wireless communication system, the method comprising steps of:
generating a first symbol sequence in which only a first symbol of data symbols to be transmitted is contiguously repeated and disposed;
generating a second symbol sequence in which only a second symbol of the data symbols to be transmitted is contiguously repeated and disposed; and
performing modulation on the first and the second symbol sequences,
wherein in the step of performing the modulation, a phase rotation is performed at a boundary changed from the first symbol sequence to the second symbol sequence.

2. The method of claim 1, wherein in the step of performing the modulation, the phase rotation is not performed in a period in which the repetition of the first symbol is maintained within the first symbol sequence.

3. The method of claim 1, wherein in the step of performing the modulation, an additional symbol is inserted into the boundary of the first symbol sequence and the second symbol sequence, wherein a phase of the additional symbol is determined to be a middle value of a phase of the first symbol sequence and a phase of the second symbol sequence.

4. The method of claim 1, wherein in the step of performing the modulation, a phase of a data symbol located at a last of the first symbol sequence is rotated based on a phase of a data symbol located at a first of the second symbol sequence.

5. The method of claim 4, wherein in the step of performing the modulation, the phase of the data symbol located at the first of the second symbol sequence is rotated based on the rotated phase of the data symbol located at the last of the first symbol sequence.

6. The method of claim 1, wherein in the step of performing the modulation, if the first symbol sequence comprises a special symbol whose phase has been previously reserved, a phase of a data symbol to be disposed to neighbor the special symbol is rotated based on the phase of the special symbol.

7. The method of claim 6, wherein in the step of performing the modulation, a phase of a third symbol located right before the special symbol is rotated so that the phase becomes a middle value of a phase of a symbol sequence to which the third symbol belongs and the phase of the special symbol.

8. The method of claim 6, wherein in the step of performing the modulation, a phase of a fourth symbol located right after the special symbol is rotated so that the phase becomes a middle value of a phase of a symbol sequence to which the fourth symbol belongs and the phase of the special symbol.

9. The method of claim 1, wherein in the step of performing the modulation, a phase of the first symbol is determined, wherein the phase of the first symbol is determined by taking into consideration phases of two data symbols located right before and right after the first symbol.

10. The method of claim 9, wherein in the step of performing the modulation, a value obtained by adding a phase value of the first symbol, a phase value of a third symbol located right before the first symbol, and a phase value of a fourth symbol located right after the first symbol and then dividing the added value by 3 is determined to be the phase value of the first symbol.

11. The method of claim 9, wherein in the step of performing the modulation, a value obtained by adding a phase value of the first symbol and any one of a phase value of a third symbol located right before the first symbol and a phase value of a fourth symbol located right after the first symbol and then dividing the added value by 2 is determined to be the phase value of the first symbol.

12. The method of claim 1, wherein:
in the step of generating the first symbol sequence, the first symbol sequence is segmented into a plurality of first subsets,
in the step of generating the second symbol sequence, the second symbol sequence is segmented into a plurality of second subsets, and
a third symbol sequence is generated by mapping the plurality of first subsets and the plurality of second subsets in accordance with a predetermined resource mapping rule.

13. The method of claim 12, wherein in the step of generating the first symbol sequence, if the first symbol sequence comprises a special symbol whose location has been previously reserved, a size of the first subset is determined based on the location of the special symbol, and the first symbol sequence is segmented into the plurality of first subsets based on the determined size.

14. A wireless device mapping a data symbol in a wireless communication system, comprising:
a transceiver unit;
a processor controlling the transceiver unit,
wherein the processor performs a procedure of generating a first symbol sequence in which only a first symbol of data symbols to be transmitted is contiguously repeated and disposed, generating a second symbol sequence in which only a second symbol of the data symbols to be transmitted is contiguously repeated and disposed, and performing modulation on the first and the second symbol sequences,
in the procedure of performing the modulation, the processor performs a phase rotation a boundary changed from the first symbol sequence to the second symbol sequence.
